(19) United States
(12) Patent Application Publication
(10) Pub. No.: US 2024/0293789 A1
(43) Pub. Date: Sep. 5, 2024

(54) Encapsulation of Functional Additives in Partially-Open Microcapsules

(71) Applicant: SAS Nanotechnologies Inc., Newark, DE (US)

(72) Inventors: Sumedh P. Surwade, Newark, DE (US); Tracy Hunter, Elkton, MD (US); Robert A. Hillman, Northampton, PA (US)

(21) Appl. No.: 18/595,120

(22) Filed: Mar. 4, 2024

Related U.S. Application Data
(60) Provisional application No. 63/488,189, filed on Mar. 3, 2023.

(51) Int. Cl. B01J 13/12; A01N 25/28; A01N 31/10; A01N 43/16; A01N 43/54; A01N 43/653; A01N 43/70; A01N 43/80; A01N 47/12; A01N 47/18; A01N 55/02; A01N 59/20; A01P 1/00; A01P 3/00; B01J 13/20; C09D 5/08; C09D 5/14; C09D 5/16; C09D 7/40; C09D 7/62; C09D 7/63; C09D 7/65

(52) U.S. Cl. CPC B01J 13/125; A01N 25/28; A01N 31/10; A01N 43/16; A01N 43/54; A01N 43/653; A01N 43/70; A01N 43/80; A01N 47/12; A01N 47/18; A01N 55/02; A01N 59/20; A01P 1/00; A01P 3/00; B01J 13/203; C09D 5/084; C09D 5/14; C09D 5/1625; C09D 7/62; C09D 7/63; C09D 7/65; C09D 7/70

(57) ABSTRACT

In one embodiment this, invention relates to preparing non-conducting polymer-based partially-open, hollow reservoirs (POHR) in the nano-size to micro-size range that encapsulate an additive, which can be released from the reservoirs. This invention also relates to methods of preparing such POHR, and for releasing the additive. This invention further relates to matrix that comprises such reservoirs and the method of preparing such matrix. This invention also relates to applications, for example in bio-active mitigation or enhancement, corrosion inhibition, lubrication, and adhesion, that benefit from using such release of a functional additive (FA).

### CROSS REFERENCE TO RELATED APPLICATIONS

This application claims the benefit of U.S. Provisional Application No. 63/488,189, filed Mar. 3, 2023, the entirety of which are incorporated herein for any and all purposes.

### FIELD OF THE INVENTION

In one embodiment this, invention relates to preparing non-conducting polymer-based partially-open, hollow reservoirs (POHR) in the nano-size to micro-size range that encapsulate an additive, which can be released from the reservoirs. This invention also relates to methods of preparing such POHR, and for releasing the additive. This invention further relates to matrix that comprises such reservoirs and the method of preparing such matrix. This invention also relates to applications, for example in bio-active mitigation or enhancement, corrosion inhibition, lubrication, and adhesion, that benefit from using such release of a functional additive (FA).

### BACKGROUND

Microencapsulation works by forming a polymer wall around a core material or an active ingredient/additive. The wall and core materials are often not compatible, so they form an emulsion of oil and water or water and oil. The wall material is then made by a chemical reaction at the interface of the emulsion under controlled conditions. The wall material may also be further strengthened by crosslinking. The final product is tiny microcapsules containing core material.

The release mechanisms of active ingredient from the microcapsules can vary depending on the needs. Some microcapsules can release their contents quickly when the wall is broken, while others can release them slowly by diffusion. The rate of release can be tuned by modifying factors such as the wall material, the wall thickness, the crosslinking, the capsule size, the core amount, and the amount of microcapsules in the matrix.

Thus, there are two critical parameters on which a successful microencapsulation depends:
(a) Encapsulation of core material during synthesis: The core material is encapsulated inside microcapsules during the synthesis of microcapsules. Therefore, compatibility of core material and the polymer wall becomes very important. Often times, the core material and polymer are not compatible or the core material affects the polymer emulsion formation and therefore, the microcapsules are not formed. This technique puts several limitations on the type of core material that can be encapsulated.
(b) Control of release rate: The complete core-shell structure, with active material as core and polymer as shell, require the polymer shell to be porous for diffusion of core material from inside the microcapsule to outside in the matrix. This puts limitation on the type of polymer shells that can be used as one polymer that might be porous or would effectively let diffuse one particular core material through it may not necessarily let other core material to diffuse through it. Also, often times, the breaking of microcapsule shell is the only effective method for the release of core material, and therefore this puts several limitation on the technology because the breaking of microcapsule shell is dependent on the external mechanical force.

The partially open and hollow structure microreservoirs of the present invention directly address these limitations as described infra. Because of the partially open structure of the microreservoirs, in one embodiment of the present invention, the POHR can encapsulate functional additives after the microreservoirs are made. This allows for the encapsulation of a variety of functional additives, thereby removing the various limitations encountered in the traditional microcapsule synthesis.

Moreover, because the microreservoirs of the present invention are partially open, the diffusion of core additive from the open pore of microreservoirs is easier with fewer limitations. The rate of release can be effectively controlled from the microreservoirs, for example, by controlling the pore size or the number of pores on the surface.

The application of the present invention is found in the below described exemplary industries.

### A. Corrosion Industry

Industries such as oil and gas, automotive, chemical plants, marine, and construction-infrastructure use metals abundantly. Corrosion of metals is one of the biggest problems in the industrial world. Corrosion incurs massive economic losses, inflicts severe environmental damage, and wastes significant resources associated with it. Corrosion often results in structural failure sometimes even leading to loss of human life. Protecting metals from corrosion renders efficient functioning and safety of these industries.

To prevent metal corrosion, coatings containing corrosion inhibiting additives are applied on the metal surface. The most effective anticorrosive coatings contain corrosion inhibiting additives of heavy metal origin: for example, chromium, zinc, lead, and their compounds. Health, safety, and environmental concerns mandate that the heavy metal based anticorrosion additives be replaced with less dangerous additives. Non-heavy metal based corrosion inhibitors, while initially effective, tend to leach out from the coating surface owing to rain and weather events, rendering the coating ineffective. Also, coatings degrade due to mechanical fatigue, or from scratches and dents due to wear, which exposes the underlying metal. The metal starts corroding immediately, making the corrosion inhibitor in anticorrosive coating ineffective.

Therefore, to improve the corrosion-inhibition longevity of the coating, the corrosion inhibitor in it should be preserved for a longer time. Encapsulating corrosion the inhibitor in reservoirs or capsules preserve them in the coatings for a longer time, as provided in the present invention.

### B. Lubricant Industry

Lubricants are used in applications that typically involve moving metal parts. They reduce the friction generated between moving parts due to wear and heating, for example. Because lubricants also coat metal parts, they help inhibit corrosion. Functional additives are added into lubricants to increase the performance. For example, a lubricant may include antioxidant additives that prevent the oil from thickening; friction modifier additives that increase engine efficiency; dispersant additives that hold contaminants in suspension; antifoam additives that inhibit the production and retention of air bubbles; detergent additives that reduce deposits on metal; and corrosion inhibiting additives to inhibit corrosion of metals.

Changing lubricant often is expensive and disposal of used lubricant contributes towards soil, and ground water contamination if not properly managed. Therefore, to increase the lubricant's life and consequently the time interval between change of lubricant, it is important to preserve the additives in lubricants for a longer time.

Encapsulating additives in reservoirs preserves them in the lubricant for a longer time, as provided in the present invention.

### C. Adhesive Industry

In electronic devices, conductive elements may be bonded to one another by means of adhesives. Manufacturers of metal components use structural adhesives to replace conventional fastening techniques such as rivets, bolts, and welding. Adhesives offer many attractive properties that include improved product performance, aesthetics, reduced overall assembly time, and lower production costs. Additionally, adhesives preclude much of the stress point concentration, corrosion, and component damage often seen with rivets, bolts, welding, and other traditional fastening methods.

There is also considerable interest in attaching two different types of materials together, e.g. in automotive applications, to reduce the overall weight of the structure. For example, the inner and outdoor panels, hoods and deck lids can be made of any combination of steel panels, aluminum panels, magnesium panels, carbon composite to satisfy structural, weight and appearance requirements of the automotive. However, the use of combination of metals presents an issue of corrosion due to galvanic action between closely spaced metal structures.

Clearly, an adhesive is a better approach than mechanical fastening. But an adhesive that comprises reservoirs encapsulated with corrosion inhibitor, as is the present invention, works even more effectively in inhibiting corrosion when two different types of metals are adhered together. Also, a curing agent encapsulated in reservoirs and added to adhesives, as provided in this invention, enables control over when the curing is desired.

### D. Bio-active Functional Additive Applications

### D1. Wood Preservation

Industries such as construction, infrastructure, residential and commercial real estate, and others use wood products in large quantities. Decay due to microorganisms is a major issue related to the use of wood products in these fields and leads to large amounts of waste and economic losses. Wood decay and deterioration can also lead to structural issues, leading to potential injury and loss of life. Protecting wood from decay renders efficient functioning and safety of these industries.

Therefore, to improve the biocidal longevity of coatings and additives, the biocide in it should be preserved for a longer time. Encapsulating the biocide in POHR or capsules preserve them in the coatings for a longer time, as provided in the present invention.

### D2. Biocides and Antifouling Applications

Coatings and paints manufacturers customarily add biocides to their product to inhibit unwanted infestation of the films by microorganisms, e.g., fungi, such as molds and yeasts, and also by bacteria, algae, and cyanobacteria (so-called “soft fouling”) when these products are applied either on a vessel or underwater structure such as a pier or on metal and building infrastructure. They have also been effective in some cases in preventing the growth of barnacles, tube worms, and the like (so-called “hard fouling”). However, the main drawback of those systems is the poor control on biocides release. Most coatings suffer from premature leakage of biocides, reducing its antifouling action before the end of coatings lifetime. Alternatively, higher biocides contents can be used to reach the required lifecycle, but the continued releasing of those toxic agents into the environment has proven to cause serious side effects on ecosystems, mainly owing to the ecotoxicity and cumulative effect of the applied bioactive agents. Therefore, rigid international regulations have been issued and more are expected to come in a near future. Therefore, ability to store biocides or antifoulants in coating for a longer time and its controlled release in coatings over time is of significant importance. Encapsulating biocides in reservoirs preserves them in the coating for a longer time, as provided in the present invention.

### D3. Pesticide Applications

Pesticides are undoubtedly critical elements of modern agricultural production. They can effectively increase crop yield by reducing plants pests and diseases. However, the traditional pesticide formulations have several disadvantages such as high organic solvent contents, dust drift, poor dispersibility and most importantly most of the pesticide is lost to the environment and less than 1% remains on the target. This low effectiveness contributes to serious environmental pollution associated with pesticides. Therefore, efforts should be taken to reduce waste, production cost and environmental pollution associated with pesticides while also extending the duration of pesticide activity on crops.

One of the methods to address these challenges would be by using precise controlled release of pesticides, an aspect of the present invention. This approach aims to minimize crop's demand for pesticides to gradually achieve more effective, safe pesticide usage through smart design that slows and controls pesticide release.

The present invention addresses the problems described above. Specifically, the present invention provides a microcapsule or a micro-reservoir that is partially-open that carries an encapsulant such as a functional additive, and releases the encapsulant at a specific location and is sustained for a longer time.

### D4. Pest Control

Use of pesticides for pest control have several disadvantages such as loss of natural antagonists to pests and pesticide resistance, Honeybee and pollination decline, losses to adjacent crops, fishery and bird losses, domestic animal contaminations and deaths, and contamination of groundwater. Farmers are adopting pesticide free pest control methods. One of the methods is to use Pest Traps to attract and trap pests inside them. The trap is loaded with insect pheromone and pests are attracted towards trap. However, since the pheromone is highly volatile, it evaporates quickly and the trap becomes ineffective in few days.

The present invention addresses the problem described above. Specifically, the present invention provides a microcapsules or a microreservoir that is partially-open that carries an insect pheromone or pest-attractant chemical inside it and releases it slowly over time. The microencapsulate pheromone when placed inside pest trap, reduces the volatility of pheromone thereby increasing the life of pest trap and thus its functionality.

### D5. Marine Industry

Marine coatings and paint manufacturers customarily add biocides to the coatings to prevent or inhibit unwanted infestation of the films by microorganisms, such as fungi, bacteria, algae, and cyanobacteria (soft fouling) when these paints or coatings are applied on a vessel or underwater structure such as a pier. They have also been effective in some cases in preventing the growth of barnacles, tube worms, and other organisms (hard fouling). However, the main drawback of those systems is poor control over the biocide release. Most coatings suffer from premature leakage of biocides, reducing its antifouling action before the end of the coating's lifetime. Alternatively, higher biocide content can be added to reach the require lifespan, but the prolonged release of toxic agents to the environment has proven to cause serious effects to the ecosystem mainly owing to ecotoxicity and cumulative effects of prolonged release of and exposure to bioactive agents. Therefore, rigid international regulations have been issued, and more are expected to come in the near future. The ability to store biocides and antifoulants in coatings for longer periods of time and to control the release of these agents in the coatings are therefore of significant importance. Encapsulating biocides in POHR preserves them in the coating for a longer time, as provided in the present invention.

### SUMMARY OF THE INVENTION

The present invention addresses the problems described above, and many other, in the above mentioned industries, as well as other industries further alluded to in the present disclosure. More specifically, the present invention provides a microcapsule or a micro-reservoir that is partially-open that carries an encapsulating material such as a functional additive, and releases the functional additive at a specific location for a longer period of time.

The present invention relates to preserving of functional additives in products using microreservoirs in the nano-size to micro-size range and delivering them to a specific site, at a specific rate. This solution is an advantageous proposition to consumer applications and in the industry having such need. Some of the industries in which this invention can be used include coatings, membranes, wood preservation, anti-fouling in the marine industry, as well as anti-mold and anti-fungal applications. This invention equally applies to other industries.

The present invention also relates to methods to encapsulate organic and inorganic moieties inside microcapsules. In one embodiment, the method involves dissolution of functional additive moieties in a solvent in presence of microcapsule and precipitating the functional additive out of solution to encapsulate it inside microcapsules. For functional additive, especially inorganic salts, that are not soluble in water as is, a pH tweaking approach is used where the pH is adjusted such that the functional additive salts dissociate and dissolve in water and then the pH readjusted back to precipitate it out of water. For functional additives, such as phosphate esters, that are soluble in solvent but insoluble in water, a water miscible solvent is used to dissolve them while an azeotropic mixture of water and solvent is created to precipitate it out of solvent. A variety of functional additives such as corrosion inhibitors, biocides, lubricant additives, pesticides, cosmetics additives, polymer catalyst, etc. can be encapsulated using this method.

In one embodiment, this invention relates to a plurality of partially-open, hollow reservoirs (POHR), comprising at least one polymeric material and optionally at least one functional additive;
wherein said at least one polymeric material comprises only non-conducting at least one polymer;
wherein said plurality of POHR have at least one opening on their surface, such that the average opening area, in the aggregate, of said plurality of POHR is from about 0.25% to about 50% of the surface area in the aggregate of said plurality of POHR;
wherein the average size of said plurality of POHR is in the range of from about 200 nm to about 30,000 nm;
wherein said at least one functional additive releasably resides in said plurality of POHR.

In another embodiment, this invention relates to a plurality of partially-open, hollow reservoirs as recited above, wherein said non-conducting at least one polymer is selected from polysulfone, poly(p-phenylene ether-sulphone), polycarbonate, polyamide, a polymeric blend comprising one of the previously recited polymers, a copolymer of one of the previously recited polymers, and a combination of previously recited polymers.

In another embodiment, this invention relates to a plurality of partially-open, hollow reservoirs as recited above, wherein said at least one functional additive is selected from the group consisting of a corrosion inhibiting additive, a lubricant additive, an adhesive additive, a bio-active additive, a fragrance-releasing additive, a drug delivery additive, an enzyme additive, a corrosion sensor additive, a catalyst additive, an ink additive, a dye additive, a cosmetic additive, a UV stabilizer, a light stabilizer, and combinations thereof.

In yet another embodiment, this invention relates to a plurality of partially-open, hollow reservoirs as recited above, wherein said bio-active functional additive is selected from the group consisting a biocide additive, a pesticide additive, a pest-attractant additive, an pest-repellant additive, an herbicide additive, an insecticide additive, an insect-attractant additive, an insect-repellant additive, a fungicide additive, a planticide additive, an antifouling additive, an antifungal additive, an anti-mold agent, a viricide additive, a pheromone, and combinations thereof.

In one embodiment, this invention relates to a plurality of partially-open, hollow reservoirs as recited above, wherein said at least one bio-active functional additive is an antifungal additive.

In another embodiment, this invention relates to a plurality of partially-open, hollow reservoirs as recited above, wherein said bio-active functional additive is selected from triazoles, imidazoles, succinates, benzamides, iodine, phenol, pyridine, quinoline, nitrides, phosphates and their respective derivatives;
inorganic, organometallic, metal-organic or organic biocide for marine or freshwater organisms, inorganic biocides selected from copper salts, copper oxide, copper thiocyanate, copper bronze, copper carbonate, copper chloride, copper nickel alloys, silver salts, silver chloride, silver nitrate;
organometallic and metal-organic biocides, zinc pyrithione (the zinc salt of 2-pyridinethiol-1-oxide), copper pyrithione, bis (N-cyclohexyl-diazenium dioxy) copper, zinc ethylene-bis(dithiocarbamate) (I.e. zineb), zinc dimethyl dithiocarbamate (ziram), manganese ethylene-bis(dithiocarbamate) complexed with zinc salt (i.e. mancozeb);
3-iodo-2-propylbutylcarbamate, propiconazole, tebuconazole, copper-8-quinolinate, copper citrate, carbendazim, streptomycin, dichlorooctylisothiazolinone, Irgarol 1051, pentachlorophenol, azoxystrobin, 1,2-benzisothiazole-3 (2H)-one (BIT), 5-chloro-2-methyl-2H-isothiazole-3-one CMIT) and 2-methyl-2H-isothiazole-3-one MIT), 4,5-dichloro-2-octyl-2-H-isothiazole-3-one (DCOIT), 2-methyl-2H-isothiazole-3-one (MIT), 2-Octyl-2H-isothiazole-3-one (OIT), dibromopropionamide (DBNPA), glutaaldehyde, 3-iodo-2-propynylbutylcarbamate (IPBC), terbutrin, 2-methyl-1,2-benzothiazole-3 (2H)-one (MBIT), benzamide, 2,2′-dithiobis (N-methyl) (DTBMA), tetramethylol-acetylenediazole (TMAD), ethylene glycol bishemiformal (EDDM), 2-bromo-2-(Bromomethyl) pentanedinitrile (DBDCB), permethrin, propiconazole (DMI), chlorocresol (PCMC), bronopol, thiabendazole (TBZ), 3-(3,4-dichlorophenyl)-1,1-dimethylurea (3,4-dichlorophenyl)-1,1-dimethylurea (DCMU; diuron), 2-benzyl-4-chlorophenol (chlorophen), phenoxycarb, tebuconazole, isothiazole, cyproconazole, fludioxonyl, azoxystrobin, Zn-pyrythion, alvendadim, thiamethaxam, quaternary ammonium compounds (“quats”) such as n-alkyl dimethyl benzyl ammonium chloride, didecyl dimethyl ammonium chloride (DDAC) or alkenyl dimethylethyl ammonium chloride, guanidines, biguanidines, pyrithiones, carbamates, 3-iodopropynyl-N-butylcarbamate, phosphonium salts such as tetrakis hydroxymethyl phosphonium sulfate (THPS), 3,5-dimethyl-1,3,5-thiadiazinane-2-thione (Dazomet), 2-(thiocyanomethylthio)benzothiazole, methylene bisthiocyanate (MBT);
Pyrethroids, bifenthrin, permethrin, deltamethrin, lambda cyhalothrin, cyfluthrin, betacyfluthrin; organophosphates, chlorpyrifos; limonoids, azadirachtin, mellartenin; phenyl pyrazoles; oxadiazines; indoxacarb; phthalic acid diamides, flubendiamide, anthranilic diamides; carbamates, carbaryl (1-naphthyl N-methylcarbamate), neonicotinoids; nitroguanidines, imidacloprid, thiomethoxam, clothianidin, dinotefuran; diacylhydrazines, halofenozide; neonicotines such as floconamid; organophosphates, trichlorfon and pyrazoles, fipronil, and combinations thereof.

In yet another embodiment, this invention relates to a plurality of partially-open, hollow reservoirs as recited above, wherein said bio-active functional additive is selected from: 3-iodo-2-propylbutylcarbamate, propiconazole, tebuconazole, copper-8-quinolinate, copper citrate, carbendazim, streptomycin, dichlorooctylisothiazolinone, Irgarol 1051, pentachlorophenol, azoxystrobin, and combinations thereof.

In one embodiment, this invention relates to a plurality of partially-open, hollow reservoirs as recited above, wherein said bio-active functional additive is selected from: 3-iodo-2-propylbutylcarbamate, propiconazole, tebuconazole, copper-8-quinolinate, 4,5-dichloro-2-octyl-2-H-isothiazole-3-one (DCOIT), Irgarol 1051, pentachlorophenol, and blends thereof, and combinations thereof.

In another embodiment, this invention relates to a plurality of partially-open, hollow reservoirs as recited above, wherein said functional additive is a corrosion inhibiting additive selected from (a) an organic compound containing an amino group or carboxy group or salts of carboxylic acids, organic sulfides, heterocyclic rings, substituted aromatic rings, organic phosphates and phosphonic acids, quaternary ammonium compounds, imidazolines, aldehydes, sulfoxides, carboxylic acids, mercaptocarboxylic acids, imidazoles, oximes, azoles, tannins, substituted phenols, quinoline and quinolone compounds, substituted quinolines and quinalizarin, pyridinium group, pyrazine group, an azole derivative, and, one or more schiffs bases; (b) an inorganic compound containing one or more anions selected from the group comprising polyphosphate and its derivatives, nitrite, silicate, molybdate, and polymolybdate and its derivatives, vanadate and polyvanadate and its derivatives; and (c) an organic or inorganic compound comprising one or more cations selected from the group comprising lanthanides, magnesium, calcium, titanium, zirconium, yttrium, chromium, zinc, strontium and silver; combinations of components within each corrosion inhibiting additive group (a), (b), and (c); and combinations between one or more components of each additive group (a), (b), and (c).

In yet another embodiment, this invention relates to a plurality of partially-open, hollow reservoirs as recited above, wherein said functional additive or encapsulating material is a lubricant additive selected from: (i) antioxidant additives selected from phenols and its derivatives, aromatic and aryl amines; (ii) anti-wear additives selected from metal alkylthiophosphate; (iii) dispersants selected from of phenates, sulfurized phenates, salicylates, naphthenates, stearates, carbamates, thiocarbamates, phosphorus derivatives; combinations of components within each lubricant additive group (i), (ii), and (iii); and combinations between one or more components of each lubricant additive group (i), (ii), and (iii).

In one embodiment, this invention relates to a plurality of partially-open, hollow reservoirs as recited above, wherein said functional additive is an adhesive additive selected from the following adhesive additive functional additives:
chromate compositions, phosphates, silicates, nitrates, benzoates, mercaptobenzothiazoles, sodium molybdate formulations, phosphonic acids combined with amines, and combinations thereof.

In another embodiment, this invention relates to a plurality of partially-open, hollow reservoirs as recited above, wherein said partially-open, hollow reservoirs are nominally spherical-shaped hollow reservoirs, nominally rod-shaped hollow reservoirs, irregular-shaped hollow reservoirs, or a hollow micro-particles with more than one opening.

In yet another embodiment, this invention relates to a method for preparing POHR comprising a first polymer, said method comprising the steps of:
(i) contacting a first aqueous solution (W1) comprising a first surfactant, or a first emulsion stabilizer, and/or a second polymer with a solution of said first polymer in a solvent (O);
(ii) emulsifying the resultant mixture of step (i) into a W1/O emulsion;
(iii) contacting said emulsion of step (ii) with a second aqueous solution (W2) comprising a second surfactant, a second emulsion stabilize, and/or a third polymer;
(iv) emulsifying the resultant mixture of step (iii) to form a W1/O/W2 emulsion; and
(v) evaporating said solvent from said W1/O/W2 emulsion;
   wherein said first surfactant is the same as or different from the second surfactant, the first emulsion stabilizer is the same as or different from the second emulsion stabilizer, and the second polymer is the same as or different from the third polymer.

In one embodiment, this invention relates to a method for encapsulating at least one functional additive (FA) in a plurality of partially-open, hollow reservoir (POHR) as recited above, or in an inorganic POHR, said method selected from the following four methods: (I) a precipitation method; (II) a solvent evaporation method; (III) a pH change method; and (IV) an in-situ method,

wherein:
I. said precipitation method comprises the steps of:
   i. dissolving at least one FA in a solvent to form a first solution in presence of said plurality of POHR, or
   ii. dissolving at least one FA in a solvent to form a second solution and contacting said second solution to said plurality of POHR; and
   iii. precipitating out said at least one FA out of said first solution or second solution in the POHR;
II. said solvent evaporation method comprises the steps of:
   iv. dissolving at least one FA in a first solvent to form a first solution, in presence of said plurality of POHR;
   v. dissolving at least one FA in a second solvent to form a second solution and contacting said second solution to said plurality of POHR; and
   v. precipitating said at least one FA out of said first solution or second solution in POHR by evaporating the first solvent or the second solvent, wherein the first solvent and the second solvent are the same or different from each other;
III. said pH change method comprises the steps of:
   vi. dissolving at least one FA in an acidic or basic medium to form a first solution, in presence of said plurality of POHR, or
   vii. dissolving at least one FA in an acidic or basic medium to form a second solution and contacting said second solution to said plurality of POHR; and
   viii. precipitating out said at least one FA out of said first solution or second solution in the POHR by changing the pH to neutral; and
IV. said in-situ method comprises the step of adding at least one FA dissolved in a solvent to the POHR synthesis reaction medium prior to the synthesis of the POHR, or during the synthesis of POHR.

In another embodiment, this invention relates to a method for encapsulating at least one functional additive (FA) in a plurality of partially-open, hollow reservoir (POHR) as recited above, wherein said non-conducting at least one polymer is selected from polysulfone, poly(p-phenylene ether-sulphone), polycarbonate, and polyamide, a polymeric blend comprising one of the previously recited polymers, a copolymer of one of the previously recited polymers, and a combination of previously recited polymers.

In yet another embodiment, this invention relates to a method for encapsulating at least one functional additive (FA) in a plurality of partially-open, hollow reservoir (POHR) as recited above, wherein said at least one functional additive is selected from the group consisting of a corrosion inhibiting additive, a lubricant additive, an adhesive additive, a bio-active additive, a fragrance-releasing additive, a drug delivery additive, an enzyme additive, a corrosion sensor additive, a catalyst additive, an ink additive, a dye additive, a cosmetic additive, a UV stabilizer, a light stabilizer, and combinations thereof.

In one embodiment, this invention relates to a method for encapsulating at least one functional additive (FA) in a plurality of partially-open, hollow reservoir (POHR) as recited above, wherein said bio-active functional additive is selected from the group consisting a biocide additive, a pesticide additive, a pest-attractant additive, an pest-repellant additive, an herbicide additive, an insecticide additive, an insect-attractant additive, an insect-repellant additive, a fungicide additive, a planticide additive, an antifouling additive, an antifungal additive, an anti-mold agent, a viricide additive, a pheromone, and combinations thereof.

In another embodiment, this invention relates to a method for encapsulating at least one functional additive (FA) in a plurality of partially-open, hollow reservoir (POHR) as recited above, wherein said bio-active functional additive is selected from triazoles, imidazoles, succinates, benzamides, iodine, phenol, pyridine, quinoline, nitrides, phosphates and their respective derivatives;
inorganic, organometallic, metal-organic or organic biocide for marine or freshwater organisms, inorganic biocides selected from copper salts, copper oxide, copper thiocyanate, copper bronze, copper carbonate, copper chloride, copper nickel alloys, silver salts, silver chloride, silver nitrate;
organometallic and metal-organic biocides, zinc pyrithione (the zinc salt of 2-pyridinethiol-1-oxide), copper pyrithione, bis (N-cyclohexyl-diazenium dioxy) copper, zinc ethylene-bis(dithiocarbamate) (i.e. zineb), zinc dimethyl dithiocarbamate (ziram), manganese ethylene-bis(dithiocarbamate) complexed with zinc salt (i.e. mancozeb);
3-iodo-2-propylbutylcarbamate, propiconazole, tebuconazole, copper-8-quinolinate, copper citrate, carbendazim, streptomycin, dichlorooctylisothiazolinone, Irgarol 1051, pentachlorophenol, azoxystrobin, 1,2-benzisothiazole-3 (2H)-one (BIT), 5-chloro-2-methyl-2H-isothiazole-3-one CMIT) and 2-methyl-2H-isothiazole-3-one MIT), 4,5-dichloro-2-octyl-2-H-isothiazole-3-one (DCOIT), 2-methyl-2H-isothiazole-3-one (MIT), 2-Octyl-2H-isothiazole-3-one (OIT), dibromopropionamide (DBNPA), glutaaldehyde, 3-iodo-2-propynylbutylcarbamate (IPBC), terbutrin, 2-methyl-1,2-benzothiazole-3 (2H)-one (MBIT), benzamide, 2,2′-dithiobis (N-methyl) (DTBMA), tetramethylol-acetylenediazole (TMAD), ethylene glycol bishemiformal (EDDM), 2-bromo-2-(Bromomethyl) pentanedinitrile (DBDCB), permethrin, propiconazole (DMI), chlorocresol (PCMC), bronopol, thiabendazole (TBZ), 3-(3,4-dichlorophenyl)-1,1-dimethylurea (3,4-dichlorophenyl)-1,1-dimethylurea (DCMU; diuron), 2-benzyl-4-chlorophenol (chlorophen), phenoxycarb, tebuconazole, isothiazole, cyproconazole, fludioxonyl, azoxystrobin, Zn-pyrythion, alvendadim, thiamethaxam, quaternary ammonium compounds (“quats”) such as n-alkyl dimethyl benzyl ammonium chloride, didecyl dimethyl ammonium chloride (DDAC) or alkenyl dimethylethyl ammonium chloride, guanidines, biguanidines, pyrithiones, carbamates, 3-iodopropynyl-N-butylcarbamate, phosphonium salts such as tetrakis hydroxymethyl phosphonium sulfate (THPS), 3,5-dimethyl-1,3,5-thiadiazinane-2-thione (Dazomet), 2-(thiocyanomethylthio)benzothiazole, methylene bisthiocyanate (MBT);
pyrethroids, bifenthrin, permethrin, deltamethrin, lambda cyhalothrin, cyfluthrin, betacyfluthrin; organophosphates, chlorpyrifos; limonoids, azadirachtin, meliartenin; phenyl pyrazoles; oxadiazines; indoxacarb; phthalic acid diamides, flubendiamide, anthranilic diamides; carbamates, carbaryl (1-naphthyl N-methylcarbamate), neonicotinoids; nitroguanidines, imidacloprid, thiomethoxam, clothianidin, dinotefuran; diacylhydrazines, halofenozide; neonicotines such as floconamid; organophosphates, trichlorfon and pyrazoles, fipronil, and combinations thereof.

In yet another embodiment, this invention relates to a method for encapsulating at least one functional additive (FA) in a plurality of partially-open, hollow reservoir (POHR) as recited above, wherein said bio-active functional additive is selected from: 3-iodo-2-propylbutylcarbamate, propiconazole, tebuconazole, copper-8-quinolinate, copper citrate, carbendazim, streptomycin, dichlorooctylisothiazolinone, Irgarol 1051, pentachlorophenol, azoxystrobin, and combinations thereof.

In one embodiment, this invention relates to a method for encapsulating at least one functional additive (FA) in a plurality of partially-open, hollow reservoir (POHR) as recited above, wherein said bio-active functional additive is selected from: 3-iodo-2-propylbutylcarbamate, propiconazole, tebuconazole, copper-8-quinolinate, 4,5-dichloro-2-octyl-2-H-isothiazole-3-one (DCOIT), Irgarol 1051, pentachlorophenol, and combinations thereof.

In another embodiment, this invention relates to a method for encapsulating at least one functional additive (FA) in a plurality of partially-open, hollow reservoir (POHR) as recited above, wherein said functional additive is a corrosion inhibiting additive is selected from selected from (a) an organic compound containing an amino group or carboxy group or salts of carboxylic acids, organic sulfides, heterocyclic rings, substituted aromatic rings, organic phosphates and phosphonic acids, quaternary ammonium compounds, imidazolines, aldehydes, sulfoxides, carboxylic acids, mercaptocarboxylic acids, imidazoles, oximes, azoles, tannins, substituted phenols, quinoline and quinolone compounds, substituted quinolines and quinalizarin, pyridinium group, pyrazine group, an azole derivative, and, one or more schiffs bases; (b) an inorganic compound containing one or more anions selected from the group comprising polyphosphate and its derivatives, nitrite, silicate, molybdate, and polymolybdate and its derivatives, vanadate and polyvanadate and its derivatives; and (c) an organic or inorganic compound comprising one or more cations selected from the group comprising lanthanides, magnesium, calcium, titanium, zirconium, yttrium, chromium, zinc, strontium and silver; combinations of components within each corrosion inhibiting additive group (a), (b), and (c); and combinations between one or more components of each additive group (a), (b), and (c).

In yet another embodiment, this invention relates to a matrix comprising the plurality of partially-open, hollow reservoirs as recited above, or an inorganic POHR comprising functional additive selected from the group consisting of a corrosion inhibiting additive, a lubricant additive, an adhesive additive, a bio-active additive, a fragrance-releasing additive, a drug delivery additive, an enzyme additive, a corrosion sensor additive, a catalyst additive, an ink additive, a dye additive, a cosmetic additive, a UV stabilizer, a light stabilizer, and combinations thereof;

wherein said bio-active functional additive is selected from the group consisting a biocide additive, a pesticide additive, a pest-attractant additive, a pest-repellant additive, an herbicide additive, an insecticide additive, an insect-attractant additive, an insect-repellant additive, a fungicide additive, a planticide additive, an antifouling additive, an antifungal additive, an anti-mold agent, a viricide additive, a pheromone, and combinations thereof.

In one embodiment, this invention relates to a process for preparing a matrix comprising the plurality of partially-open, hollow reservoirs as recited above or an inorganic POHR comprising such FA, comprising the steps of:
i. contacting said POHR with said matrix, and optionally
ii. mixing said POHR in said matrix.

In another embodiment, this invention relates to a process for preparing a matrix comprising the plurality of partially-open, hollow reservoirs as recited above, wherein said matrix is a paint, coating wood preservative, paint, coating, or a polymeric material;
wherein and said at least one functional additive is selected from the group consisting of a corrosion inhibiting additive, a lubricant additive, an adhesive additive, a bio-active additive, a fragrance-releasing additive, a drug delivery additive, an enzyme additive, a corrosion sensor additive, a catalyst additive, an ink additive, a dye additive, a cosmetic additive, a UV stabilizer, a light stabilizer, and combinations thereof; and
wherein said bio-active functional additive is selected from the group consisting a biocide additive, a pesticide additive, a pest-attractant additive, a pest-repellant additive, an herbicide additive, an insecticide additive, an insect-attractant additive, an insect-repellant additive, a fungicide additive, a planticide additive, an antifouling additive, an antifungal additive, an anti-mold agent, a viricide additive, a pheromone, and combinations thereof.

In yet another embodiment, this invention relates to a process for preparing a matrix comprising the plurality of partially-open, hollow reservoirs as recited above, wherein the matrix is injected or applied alone or as a component in latexes, amino resins, polyurethanes, epoxies, phenolic resins, polyester resins, alkyd resins, polyaspartic, polyurea, polylactones, adducts of amines, polyimide, polycarbonate, polyvinyl and halogenated polymer resins.

In one embodiment, this invention relates to a process for initiating biological activity on a surface, comprising the step of coating said surface with a matrix comprising the partially-open, hollow reservoirs as recited above or an inorganic POHR comprising functional additive, wherein the functional additive is selected from the group consisting a biocide additive, a pesticide additive, a pest-attractant additive, an pest-repellant additive, an herbicide additive, an insecticide additive, an insect-attractant additive, an insect-repellant additive, a fungicide additive, a planticide additive, an antifouling additive, an antifungal additive, an anti-mold agent, a viricide additive, a pheromone, and combinations thereof.

In another embodiment, this invention relates to a process for initiating biological activity on a surface as recited above, wherein the matrix coating is latexes, amino resins, polyurethanes, epoxies, phenolic resins, acrylic resins, polyester resins, alkyd resins, polysulfide resins, polyaspartic, polyurea, polylactones, adducts of amines, polyimide, polycarbonate, polyvinyl and halogenated polymer resins.

In yet another embodiment, this invention relates to a process for initiating biological activity on a surface as recited above, wherein said surface is part of a fence, deck, part of a pier, marine vehicle, marine vehicle part, or part of a piece of equipment, architectural cladding, flying object, or part of a flying object, industrial machinery, or industrial machinery parts, pipes, pipe parts, tanks, tank parts, part of a decorative piece, and a part for decorative purposes, structures used in power sector or other infrastructure, wood or metal structures used in energy sector, and wood or metal structures used in the transportation sectors.

### BRIEF DESCRIPTION OF DRAWINGS

FIG. 1 relates to scanning electron micrograph images of partially-open and hollow reservoirs (POHR) of (a) polycarbonate (b) polysulfone (c) poly(p-phenylene ether-sulphone) (d) polyamide (e) polyamide+polysulfone (f) poly(p-phenylene ether-sulphone) (porous from all sides), prepared by the methods of the present invention.

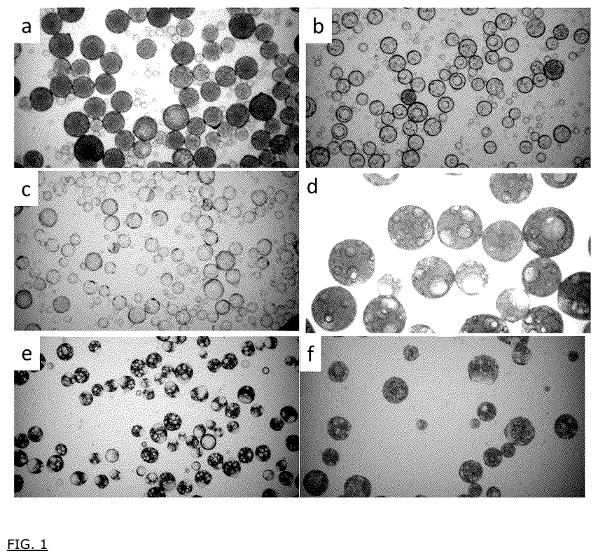

FIG. 2 relates to scanning electron micrograph images of porous microcapsules of (A) polycarbonate, (B) poly(p-phenylene ether-sulphone), (C) polysulfone, (D) polyamide, prepared by the methods of the present invention.

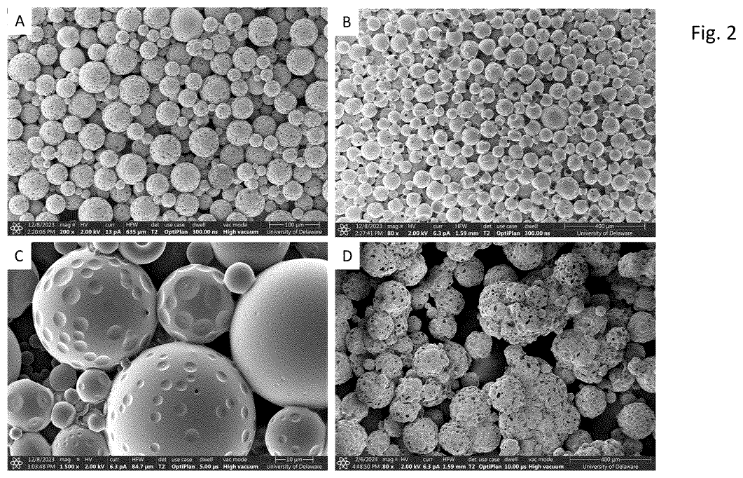

FIG. 3 relates to scanning electron micrograph images of porous microcapsules encapsulated with biocide DCOIT (A) polycarbonate microcapsules encapsulated with DCOIT using solvent evaporation method, (B) poly(p-phenylene ether-sulphone) microcapsules encapsulated with DCOIT using precipitation method, (C) polysulfone microcapsules encapsulated with DCOIT using in-situ deposition method.

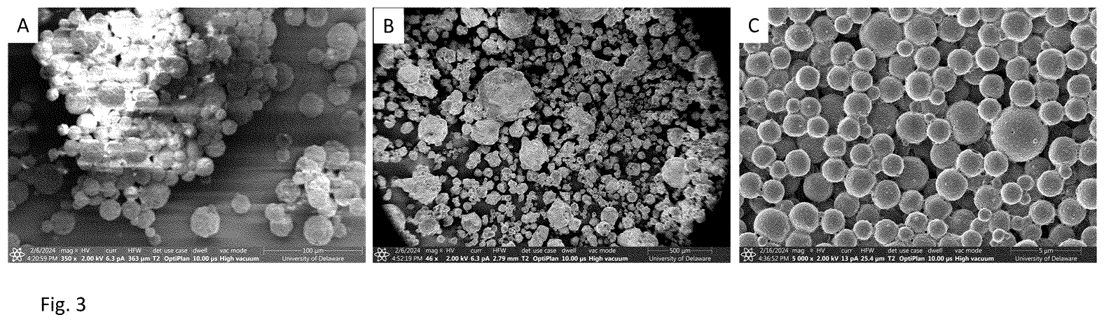

### DESCRIPTION OF THE INVENTION

Before the present compositions, articles, devices, and/or methods are disclosed and described, it is to be understood that the aspects described below are not limited to specific methods as such may, of course, vary. It is also to be understood that the terminology used herein is for the purpose of describing particular aspects only and is not intended to be limiting. As used in the specification and in the claims, the term “comprising” may include the embodiments “consisting of” and “consisting essentially of.”

Disclosed are materials, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. Thus, if a class of adhesives A, B, and C are disclosed as well as a class of additives D, E, and F and an example of a combination A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, compositions, and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

Unless expressly stated otherwise, it is not intended that any method outlined herein be construed as requiring that its steps be performed in a particular order. Accordingly, where a method claim does not expressly recite an order to be followed by its steps, or where neither the claims nor the descriptions specifically state that the steps are to be limited to a precise sequence, it should not be inferred that a specific order is intended or required. This holds for any possible non-express basis for interpretation, including but not limited to: logical flow or arrangement of steps; interpretations derived from the grammatical organization, syntax, or punctuation; and the quantity or variety of embodiments detailed in the specification. The description of the invention should not be read as mandating a fixed sequence of steps, unless such a requirement is articulated explicitly.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Unless stated otherwise, all percentages, parts, ratios, etc., are by weight. Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

Unless stated otherwise, pressures expressed in psi units would be gauge, and pressures expressed in kPa units would be absolute. Pressure differences, however, are expressed as absolute (for example, pressure 1 is 25 psi higher than pressure 2).

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used, it is used to mean a certain effect or result can be obtained within a certain tolerance, and the skilled person knows how to obtain the tolerance. When the term “about” is used in describing a value or an endpoint of a range, the disclosure should be understood to include the specific value or endpoint referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Optional additives as defined herein, at a level that is appropriate for such additives, and minor impurities are not excluded from a composition by the term “consisting essentially of”.

Further, unless expressly stated to the contrary, “or” and “and/or” refers to an inclusive and not to an exclusive. For example, a condition A or B, or A and/or B, is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise. As used in the specification and the appended claims, the singular forms “a,” “an,” and “the” include plural referents unless the context clearly dictates otherwise.

The term “predominant portion” or “predominantly”, as used herein, unless otherwise defined herein, means greater than 50% of the referenced material. If not specified, the percent is on a molar basis when reference is made to a molecule (such as hydrogen and ethylene), and otherwise is on a weight basis (such as for additive content).

The term “substantial portion” or “substantially”, as used herein, unless otherwise defined, means all or almost all or the vast majority, as would be understood by the person of ordinary skill in the context used. It is intended to take into account some reasonable variance from 100% that would ordinarily occur in industrial-scale or commercial-scale situations.

All parts, percentages and ratios used herein are expressed by weight unless otherwise specified.

In this specification and in the claims which follow, reference will be made to a number of terms which shall be defined herein.

“Optional” or “optionally” means that the subsequently described event or circumstance can or cannot occur, and that the description includes instances where the event or circumstance occurs and instances where it does not.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification. Throughout this application, various publications are referenced. The disclosures of these publications in their entireties are hereby incorporated by reference into this application in order to more fully describe the state of the art to which they pertain. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which can require independent confirmation. In the context of the present description, all publications, patent applications, patents and other references mentioned herein, if not otherwise indicated, are explicitly incorporated by reference herein in their entirety for all purposes as if fully set forth.

### A. Definitions

By partially-open, hollow reservoirs (POHR) is meant hollow structures that have at least one opening on its surface, and a hollow interior that can optionally be a repository or storage of one or more encapsulated materials. In one embodiment, the POHR can be organic, inorganic, or organic/inorganic hybrid type. Preferably, the POHR of the present invention are polymer-based.

By “partially-open” in the present disclosure is meant that in a plurality of the POHR, a substantial number have at least one opening on its surface. That substantial number of the plurality of the POHR can also have two, or three, or four, or multiple openings on their surface. They mean the one and the same structure. In a plurality of micro-reservoirs, it is possible that a nominal amount of the micro-reservoirs are closed structures.

Partially-open, hollow microcapsules (POHM) has the same meaning as POHR as defined supra. POHM and POHR or their full forms are use alternatively in the specification, but have the same meaning. Similarly, in this disclosure, POHR, reservoirs, micro-reservoirs, and nano-reservoirs, and microcapsules have the same meaning and are used interchangeably.

By “incorporating” or “incorporation of” material A into material B, is meant the embedding material A into material B, where material A can be in contact of or adhered to the surface of material B or on the inside of material B, or partially on the surface of material B and partially within the material B. So, for example, incorporating a functional additive into a POHR means the functional additive can reside on the inside of the POHR, and/or on the surface of the POHR.

By “in microcapsule” or “in POHR” when discussing the functional additive being in the POHR, it is meant that such functional additive in incorporated into the POHR or microcapsule.

By “functional additive” or “encapsulated material” is meant an additive that is amenable to encapsulation, for example, by being generally soluble in a solvent—for example, an organic solvent—and that which is subsequently incorporated or encapsulated in the partially-open, hollow reservoirs (POHR), and that which is generally available for release at a later point in time, as a result of mechanical damage to the POHR or a gradual release over time. Generally the functional additive has functional attributes as discussed infra. But in some instances, the encapsulated material may include a non-functional material.

By “releasably resides” is meant that the functional additive residing in the POHR or incorporated in the POHR has a likelihood of release at a later point in time. Without wishing to be bound by theory, it is speculated that the release of the functional additive can occur as a result of mechanical damage, shearing of the walls of the POHR, and/or a gradual release over time—as opposed to immediately—as a result of the partially-open configuration of the partially-open, hollow reservoir. Other possible mechanisms, without wishing to be bound by any theory, include diffusion mechanism through the walls of the POHR or the opening in the POHR, or through liquid based softening of the walls of the POHR and/or leaching of the functional additive from the POHR.

By “plurality of POHR” is meant that the POHR are in multiple numbers owing to their size. Plurality also implies that it can include microcapsules made from one or more polymers, each type of polymeric microcapsules having various types of functional additives. So, if P1, P2, P3 . . . are polymers, and f1, f2, f3, . . . are functional additives, the plurality of POHR would also represent a combination such as expressed by this mathematical expression: P1f1+P1f2+P2f1+P2f3+P1f1f2+P2f2f3f4.

Therefore, the average size of the POHR is really the average particle size of a plurality of the POHR.

By “non-conducting polymer” is meant a polymer that is not conducting in the general sense found in the polymer literature.

By “average size of plurality of POHR” is meant the average diameter of the plurality of POHR assuming each POHR was a full sphere equivalent in surface area to the regular-shaped or irregular-shaped POHR as if they are fully-closed spheres. For example, if a POHR is an irregular-shaped sphere, or an oblong-shaped microstructure, its size is determined as that of the diameter of a hypothetical perfect sphere having the same surface area.

By “average opening area of the POHR” is meant the percent of the hypothetical perfect sphere that would remain open owing to the partially-open configuration of the plurality of the POHR.

By a “bio-active functional additive” is meant a functional additive that can impact a biological activity, either in enhancing the outcome or mitigating the outcome in a substrate to which it may be applied to. So, for example, an insecticide type of functional additive would assist in mitigating the spread of insects-a biological activity. Similarly, an insect-repellant type of functional additive would repel the insects. But an insect-attractant functional additive could attract insects at the locus of the release of the functional additive.

In one embodiment, this invention relates to partially-open, hollow microcapsules (POHM), or partially-open, hollow reservoirs (POHR) comprising non-conducting polymers. In another embodiment, this invention relates to such POHR comprising a functional additive (FA) that releasably resides in the POHR. In yet another embodiment, this invention relates to a matrix that comprises such POHR with and without the functional additive. In one embodiment, this invention relates to an article comprising such matrix comprising such POHR with and without the FA.

In one embodiment, this invention relates to a process for preparing such POHR. In another embodiment, this invention relates to a process for incorporating the functional additive in the POHR. In yet another embodiment, this invention relates to a process for incorporating the POHR without the FA and POHR with the FA into a matrix. In one embodiment, this invention relates to a process for incorporating into an article a matrix comprising a POHR with and without the functional additive.

### B. Partially-Open and Hollow Reservoirs (POHR)

In one embodiment, the POHR, POHM, or the microcapsule can be organic, inorganic, or organic/inorganic hybrid type. Example of inorganic microcapsules include those made from silica, clay, quartz, titanium dioxide, kaolin, and the like. Organic POHR are made from polymeric materials comprising one or more of only non-conducting polymers, such as polycarbonate, polysulfone, poly(p-phenylene ether-sulphone), and polyamide.

The polymeric materials of the POHR include polymer blends comprising one or more of the recited non-conducting polymers. For clarity, a blend of a polymer is meant to include polymers other than what are listed herein. So, for example, a blend of polyamide includes polyamide and a polymer not included in the list of polycarbonate, polysulfone, and poly(p-phenylene ether-sulphone). The blend also includes two or more polymers from the list and other polymers not included in the list of polymers. The blend includes a homogeneous blend or a compatibilized blend.

The polymeric materials of the POHR include copolymers comprising one or more of the organic POHR are made from polymeric materials comprising one or more of only non-conducting polymers, such as polycarbonate, polysulfone, poly(p-phenylene ether-sulphone), and polyamide. So, a copolymer of polyamide may include a polymer—in a copolymer configuration—that is listed as a non-conducting polymer herein, as well as a non-conducting polymer not listed herein.

For the blend or the copolymer in the polymeric material of the POHR, at least one of the listed non-conducting polymers is present.

The POHR of the present invention have an average size ranging from 200 nm to 30,000 nm (300 μm) in effective diameter. In other words, the average size of a plurality of the POHR is any one of the following numbers, in nm: 200, . . . , 250, . . . , 300, . . . , 350, . . . , 400, . . . , 450, . . . , 500, . . . , 550, . . . , 600, . . . , 650, . . . , 700, . . . , 750, . . . , 800, 850, . . . , 900, . . . , 950, . . . , 1000, . . . , 2000, . . . , 3000, . . . , 4000, . . . , 5000, . . . , 6000, . . . , 7000, . . . , 8000, . . . , 9000, . . . , 10000, . . . , 12000, . . . , 14000, . . . , 16000, . . . 18000, . . . , 20000, . . . , 22000, . . . , 24000, . . . , 26000, . . . , 28000, . . . , 29000, . . . , 29500, . . . , and 30000.

In one embodiment, the average size of the POHR is in the range defined by any two numbers above, including the endpoints. By the spacing in between two numbers above is meant that the intermediate numbers are also disclosed herein. The spacing is provided simply for brevity.

In one embodiment, a combination of POHR with one or more and a variety of openings allows for a desired release profile of the encapsulated material or the functional additive. For example, in one embodiment, the present invention provides for microreservoirs that have an opening in the range of 0.25% to about 50% of the surface area of an effective sphere having equivalent surface area as a POHR microreservoir. In other words, the average size of the opening in percentage terms can be any number from the list below: 0.25, 0.5, 0.75, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, and 50.

In one embodiment, the average size of the openings is within a range defined by any two numbers given above, including the endpoints. A desired distribution of microreservoir opening sizes can be prepared, for example, by blending two or more batches of such microreservoirs. For example, in one distribution, the 25% of the microreservoirs have 20% average opening size, 25% microreservoirs have 30% average opening size, 25% microreservoirs have 35% average opening size, and 25% microreservoirs have 40% average opening size.

The reservoirs can be of variety of shapes such as capsular, spherical, tubular, and porous hollow particulates. In one embodiment, generally the POHR are irregular spheres with one or more openings or pores or holes on their surface. In many embodiments, the spheres are not fully formed, which contributes to providing the partial openness of the POHR. In one embodiment, the POHR have multiple openings on the surface, wherein the openings have a mesh-like structure, at least partially, on the surface of the micro-reservoirs.

C. Process for Preparing POHR from Non-Conducting Polymers

In one embodiment of the invention that relates to preparing POHR, the process employs surfactant or emulsion stabilizer in general. In one embodiment, partially-open, hollow microcapsules (POHR) or porous microcapsules are synthesized using water/oil/water emulsion method. In one embodiment, an aqueous solution comprising a surfactant or emulsion stabilizer (W1) is combined with a polymer solution in a solvent (O). This mixture is emulsified resulting in a W1/O emulsion. Subsequently, another aqueous surfactant or emulsion stabilizer solution (W2) is added to the emulsion to form a W1/O/W2 emulsion. The solvent is evaporated to yield partially-open hollow reservoirs or porous microcapsules.

In one embodiment, initially, an aqueous solution of 1% surfactant or emulsion stabilizer (W1) was combined with a 10 wt % polymer solution in dichloromethane (O). This mixture was emulsified using a high-speed stirrer, resulting in a W1/O emulsion. Subsequently, an additional 1% aqueous surfactant or emulsion stabilizer solution (W2) was added to the emulsion with stirring to form a W1/O/W2 emulsion. The entire system was stirred at 35° C. to facilitate the evaporation of dichloromethane, ultimately yielding polymeric microcapsules with porous structures.

In another embodiment of the invention that relates to preparing POHR, the process employs poly vinyl alcohol or PVA. Porous microcapsules are synthesized using water/oil/water emulsion method. Initially, an aqueous solution of polyvinyl alcohol (W1) is combined with a polymer solution in a solvent (O). This mixture is emulsified resulting in a W1/O emulsion. Subsequently, additional aqueous polyvinyl alcohol solution (W2) is added to the emulsion, forming a W1/O/W2 emulsion. The solvent is evaporated to yield polymeric partially-open, hollow reservoirs or porous microcapsules.

In one exemplary embodiment of the invention that relates to preparing POHR, the process employs poly vinyl alcohol or PVA. Porous microcapsules were synthesized using water/oil/water emulsion method. Initially, an aqueous solution of 1% polyvinyl alcohol (W1) was combined with a 10 wt % polymer solution in dichloromethane (O). This mixture was emulsified using a high-speed stirrer, resulting in a W1/O emulsion. Subsequently, an additional 1% aqueous polyvinyl alcohol solution (W2) was added to the emulsion, forming a W1/O/W2 emulsion. The entire system was stirred at 35° C. to facilitate the evaporation of dichloromethane, ultimately yielding polycarbonate microcapsules with porous structures

In another aspect, the invention relates to the method of encapsulating functional additives comprising the steps of:
dissolving at least one functional additive in a liquid medium to form a solution, either in the presence of already formed partially open and hollow reservoirs or the polymer that would be assembled in the form of partially open and hollow reservoirs;
precipitating the functional additive outside the solution resulting in precipitation of functional additive inside partially open and hollow reservoirs. The precipitation of functional additive outside the solution is carried out either by (a) changing the pH; (b) adding a third solvent; (c) evaporation of the dissolving medium; and (d) changing the temperature of the mixture.

### D. Functional Additives or Encapsulated Materials Encapsulated in Partially-Open, Hollow Reservoirs (POHR)

By “functional additive” or “encapsulated material” is meant an additive that is amenable to encapsulation, for example, by being generally soluble in a solvent—for example, an organic solvent—and that which is subsequently incorporated or encapsulated in the partially-open, hollow reservoirs (POHR), and that which is generally available for release at a later point in time, as a result of mechanical damage to the POHR or a gradual release over time. Generally the functional additive has functional attributes as discussed infra. But in some instances, the encapsulated material may include a non-functional material. The functional additive to be encapsulated in the POHR is generally soluble or can be dispersed in organic, inorganic, or aqueous media. Dispersion includes colloidal suspensions, emulsions, and the like. Generally, the encapsulated material or the functional additive resides in, or is encapsulated in, the hollow interior of the POHR. Separately, however, this invention also envisions the encapsulated material being adsorbed on the external surface of the POHR. The process of encapsulation in the partially-open, hollow reservoirs is described infra.

In one embodiment of the invention, a functional additive that is likely to be encapsulated includes one or more of a corrosion inhibiting additive, a lubricant additive, an adhesive additive, a bio-active additive, a drug delivery additive, a corrosion sensor additive, a cosmetic additive, a fragrance-releasing additive, an enzyme additive, a drug delivery additive, a catalyst additive, an ink additive, a dye additive, a UV stabilizer, a light stabilizer, and combinations thereof.

In one embodiment of the invention, the POHR comprise at least one type of encapsulated material. For example, the POHR may comprise an encapsulated material or functional additive E1. In another example, the POHR may comprise two encapsulated materials or functional additives, E1 and E2, and so on and so forth. To be clear, what is meant for this embodiment is that, generally, the microreservoir comprises both encapsulated materials, for example, E1 and E2.

In another embodiment, a substantial percent of plurality of POHR comprises at least one type of encapsulated material or functional additive, while some of the POHR may not have any encapsulated material. For example, in one embodiment, a substantial percent of the POHR comprises the encapsulated material or functional additive E1, and some POHR may not have any encapsulated material or functional additive. In another example, a substantial percent of the POHR comprise both encapsulated materials E1 and E2, and some POHR may not have any encapsulated material.

In yet another embodiment, some of the partially-open, hollow reservoirs (POHR) have one type of encapsulated material or functional additive, some POHR have another type of encapsulated material or functional additive, some other POHR have yet another type of encapsulated material or functional additive, and so on, and so forth. For example, some POHR comprise encapsulated material E1, some POHR comprise encapsulated material E2, and some other POHR comprise encapsulated material E3.

In one embodiment, in a given plurality of POHR, a first set of the POHR may have one or more type of encapsulated materials, a second set of the POHR may have one or more type of encapsulated materials, but at least one encapsulated material is a different type of encapsulated material between the two sets. For example, the first set may have encapsulated material E1, and the second set may have encapsulated material E2; or the first set may have encapsulated materials E1 and E2, and the second set may have the encapsulated material E2; or the first set may have encapsulated materials E1, E2, and E3, and the second set may have encapsulated materials E2 and E3. Similarly, this embodiment envisions a plurality of POHR comprising multiple sets of POHR, wherein each set of POHR has one or more encapsulated materials, such that at least one encapsulated material is different between any two sets of POHR comprising such encapsulated materials.

Stated another way, if Pi represent various sets of POHR, and Ej represent various types of encapsulated materials, this invention envisions various one or more sets of POHR, comprising one or more encapsulated materials:
ΣPi (ΣEj)
wherein the parenthesis signifies encapsulation;

Pi is a set of POHR, wherein i varies from 1-10;
Ej is an encapsulated material, wherein j varies from 1-10; and
Σ denotes addition.

Encapsulated materials with many functionalities, vel non, can be added to a POHR. Such functional additives include for example bio-active functional additives such biocidal additives and anti-fouling additives, which can be combined with other additives.

Non-exhaustive list of useful solvents useful for solubilizing or dispersing the encapsulated materials or functional additives are provided in Table 1.

TABLE 1
Solvents for Encapsulation
Common solvents used for the encapsulated materials of the
present invention include the ones in the following table:

| | | | boiling | melting | | solubility | | flash |
|---|---|---|---|---|---|---|---|---|
| | | | point | point | density | in water | Dielectric | point |
| Solvent | Formula | MW | (° C.) | (° C.) | (g/mL) | (g/100 g) | Constant^{3, 4} | (° C.) |
| acetic acid | C₂H₄O₂ | 60.052 | 118 | 16.6 | 1.0446 | Miscible | 6.20 | 39 |
| benzene | C₆H₆ | 78.11 | 80.1 | 5.5 | 0.8765 | 0.18 | 2.28 | −11 |
| 1-butanol | C₄H₁₀O | 74.12 | 117.7 | −88.6 | 0.8095 | 6.3 | 17.8 | 37 |
| 2-butanol | C₄H₁₀O | 74.12 | 99.5 | −88.5 | 0.8063 | 15 | 17.26 | 24 |
| 2-butanone | C₄H₈O | 72.11 | 79.6 | −86.6 | 0.7999 | 25.6 | 18.6 | −9 |
| t-butyl alcohol | C₄H₁₀O | 74.12 | 82.4 | 25.7 | 0.7887 | Miscible | 12.5 | 11 |
| chlorobenzene | C₆H₅Cl | 112.56 | 131.7 | −45.3 | 1.1058 | 0.05 | 5.69 | 28 |
| cyclohexane | C₆H₁₂ | 84.16 | 80.7 | 6.6 | 0.7739 | 0.0055 | 2.02 | −20 |
| diethylene glycol | C₄H₁₀O₃ | 106.12 | 246 | −10 | 1.1197 | 10 | 31.8 | 124 |
| diethyl ether | C₄H₁₀O | 74.12 | 34.5 | −116.2 | 0.713 | 7.5 | 4.267 | −45 |
| diglyme (diethylene | C₆H₁₄O₃ | 134.17 | 162 | −68 | 0.943 | Miscible | 7.23 | 67 |
| glycol | | | | | | | | |
| dimethyl ether) | | | | | | | | |
| 1,2-dimethoxy- | C₄H₁₀O₂ | 90.12 | 84.5 | −69.2 | 0.8637 | Miscible | 7.3 | −2 |
| ethane (glyme, DME) | | | | | | | | |
| 1,4-dioxane | C₄H₈O₂ | 88.11 | 101.1 | 11.8 | 1.033 | Miscible | 2.21(25) | 12 |
| ethanol | C₂H₆O | 46.07 | 78.5 | −114.1 | 0.789 | Miscible | 24.6 | 13 |
| ethyl acetate | C₄H₈O₂ | 88.11 | 77 | −83.6 | 0.895 | 8.7 | 6(25) | −4 |
| ethylene glycol | C₂H₆O₂ | 62.07 | 195 | −13 | 1.115 | Miscible | 37.7 | 111 |
| glycerin | C₃H₈O₃ | 92.09 | 290 | 17.8 | 1.261 | Miscible | 42.5 | 160 |
| heptane | C₇H₁₆ | 100.20 | 98 | −90.6 | 0.684 | 0.01 | 1.92 | −4 |
| Hexamethylphosphoramide | C₆H₁₈N₃OP | 179.20 | 232.5 | 17.2 | 1.03 | Miscible | 31.3 | 105 |
| (HMPA) | | | | | | | | |
| Hexamethylphosphorous | C₆H₁₈N₃P | 163.20 | 150 | −44 | 0.898 | Miscible | ?? | 26 |
| triamide (HMPT) | | | | | | | | |
| hexane | C₆H₁₄ | 86.18 | 69 | −95 | 0.659 | 0.0014 | 1.89 | −22 |
| methanol | CH₄O | 32.04 | 64.6 | −98 | 0.791 | Miscible | 32.6(25) | 12 |
| methyl t-butyl | C₅H₁₂O | 88.15 | 55.2 | −109 | 0.741 | 5.1 | ?? | −28 |
| ether (MTBE) | | | | | | | | |
| nitromethane | CH₃NO₂ | 61.04 | 101.2 | −29 | 1.382 | 9.50 | 35.9 | 35 |
| pentane | C₅H₁₂ | 72.15 | 36.1 | −129.7 | 0.626 | 0.04 | 1.84 | −49 |
| Petroleum ether | — | — | 30-60 | −40 | 0.656 | — | — | −30 |
| (ligroine) | | | | | | | | |
| 1-propanol | C₃H₈O | 60.10 | 97 | −126 | 0.803 | Miscible | 20.1(25) | 22 |
| 2-propanol | C₃H₈O | 60.10 | 82.4 | −88.5 | 0.785 | Miscible | 18.3(25) | 12 |
| pyridine | C₅H₅N | 79.10 | 115.2 | −41.6 | 0.982 | Miscible | 12.3(25) | 17 |
| toluene | C₇H₈ | 92.14 | 110.6 | −93 | 0.867 | 0.05 | 2.38(25) | 4 |
| triethyl amine | C₆H₁₅N | 101.19 | 88.9 | −114.7 | 0.728 | 0.02 | 2.4 | −11 |
| water | H₂O | 18.02 | 100.00 | 0.00 | 0.998 | — | 78.54 | — |
| water, heavy | D₂O | 20.03 | 101.3 | 4 | 1.107 | Miscible | ?? | — |
| o-xylene | C₈H₁₀ | 106.17 | 144 | −25.2 | 0.897 | Insoluble | 2.57 | 32 |
| m-xylene | C₈H₁₀ | 106.17 | 139.1 | −47.8 | 0.868 | Insoluble | 2.37 | 27 |
| p-xylene | C₈H₁₀ | 106.17 | 138.4 | 13.3 | 0.861 | Insoluble | 2.27 | 27 |

In one embodiment, this invention relates to a process for preparing such POHR. In another embodiment, this invention relates to a process for incorporating the functional additive in the POHR. In yet another embodiment, this invention relates to a process for incorporating the POHR without the FA and POHR with the FA into a matrix. In one embodiment, this invention relates to a process for incorporating into an article a matrix comprising a POHR with and without the functional additive.

### E. Method of Encapsulating the Encapsulated Materials or the Functional Additive in the POHR

In one embodiment, this invention relates to method of encapsulating organic and inorganic moieties inside microcapsules or polymeric partially-open hollow reservoirs (POHR). The microcapsules can encapsulate one or more functional additives in the nano-size to micro-size range that encapsulate, and which can be released from the reservoirs using slow release of the functional additive over time. The method involves dissolution of functional additive or the encapsulating material in a solvent in presence of microcapsule and precipitating the encapsulating material out of solution to encapsulate it inside microcapsules. For encapsulating materials, especially inorganic salts, that are not soluble in water as is, a pH tweaking approach is used where the pH is adjusted such that the encapsulating material salts dissociate and dissolve in water and then the pH is readjusted back to precipitate it out of water. For encapsulating material, such as phosphate esters, that are soluble in solvent but insoluble in water, a water-miscible solvent is used to dissolve them while an azeotropic mixture of water and solvent is created to precipitate it out of solvent. A variety of functional additives such as corrosion inhibitors, lubricant additives, bio-active functional additives, cosmetic additives, polymer catalyst, and the like, can be encapsulated using this method.

In one embodiment of the present invention, the additives or encapsulated materials are encapsulated in the partially-open, hollow reservoirs, by three methods namely: (a) solvent evaporation; (b) in-situ deposition; and (c) precipitation.

### (a) Solvent Evaporation Method

In this method, a saturated encapsulated material solution is prepared in its volatile solvent. Partially-open, hollow reservoirs (POHR) are added to the encapsulated material solution and stirred for few hours to ensure that the encapsulated material solution seeps inside the POHR, or is sufficiently adsorbed. The solution is then heated to remove the solvent resulting in reservoirs encapsulated with the encapsulated material. Clearly, one or more types of encapsulated materials can be used as long as the solvent is amenable to preparing a solution of the one or more types of encapsulated materials.

### (b) In-Situ Deposition Method

In this method, the encapsulated material is added during the synthesis of the partially-open, hollow microreservoirs (POHR). It is theorized, without being bound by such theory, that due to interaction of encapsulated material moieties and polymer, the encapsulated material moiety enters the polymer emulsion droplet during microcapsule synthesis, resulting in formation of POHR encapsulated with the encapsulated material. Clearly, one or more types of encapsulated materials can be used for the in situ deposition of the encapsulated material. This technique does not necessarily require that the encapsulated material be dissolved in a solvent to form a solution.

### (c) Precipitation Method

In this method, a saturated encapsulated material solution is prepared in a water miscible solvent. POHR are added to the encapsulated material solution and stirred for few hours to make sure that the encapsulated material solution seeps inside the POHR, or is sufficiently adsorbed. The solution is then added to ice-cold water such that the encapsulated material precipitates out of the solution resulting in encapsulated material encapsulated within the micro-reservoirs. The solvent and water are removed by standard methods.

### (d) Encapsulation of Inorganic Salts Inside Microcapsules

The solubility of many compounds depends strongly on the pH of the solution. For example, the anion in many sparingly soluble salts is the conjugate base of a weak acid that may become protonated in solution. In addition, the solubility of simple binary compounds such as oxides and sulfides, both strong bases, is often dependent on pH. The anion in many sparingly soluble salts is the conjugate base of a weak acid. At low pH, protonation of the anion can dramatically increase the solubility of the salt. Oxides can be classified as acidic oxides or basic oxides. Acidic oxides either react with water to give an acidic solution or dissolve in strong base; most acidic oxides are nonmetal oxides or oxides of metals in high oxidation states. Basic oxides either react with water to give a basic solution or dissolve in strong acid; most basic oxides are oxides of metallic elements. Oxides or hydroxides that are soluble in both acidic and basic solutions are called amphoteric oxides. Most elements whose oxides exhibit amphoteric behavior are located along the diagonal line separating metals and nonmetals in the periodic table. In solutions that contain mixtures of dissolved metal ions, the pH can be used to control the anion concentration needed to selectively precipitate the desired cation.

Taking into account this pH dependent solubility and precipitation of compounds, the present invention, as one of its embodiments, has developed a method to encapsulate salts inside microcapsules.

### (e) Encapsulation of Bio-Active Functional Additives in Microcapsules

In one embodiment, the bio-active functional additive is selected from the group consisting a biocide additive, a pesticide additive, a pest-attractant additive, a pest-repellant additive, an herbicide additive, an insecticide additive, an insect-attractant additive, an insect-repellant additive, a fungicide additive, a planticide additive, an antifouling additive, an antifungal additive, an anti-mold agent, a viricide additive, a pheromone, and combinations thereof.

In one embodiment, the preferred bio-active functional additive is an antifungal additive.

For the present invention, bio-active functional additives include one or more of the following: 3-iodo-2-propylbutylcarbamate, propiconazole, tebuconazole, copper-8-quinolinate, copper citrate, carbendazim, streptomycin, Irgarol 1051, pentachlorophenol, azoxystrobin, 1,2-benzisothiazole-3 (2H)-one (BIT), 5-chloro-2-methyl-2H-isothiazole-3-one CMIT) and 2-methyl-2H-isothiazole-3-one MIT), 4,5-dichloro-2-octyl-2-H-isothiazole-3-one (DCOIT), 2-methyl-2H-isothiazole-3-one (MIT), 2-Octyl-2H-isothiazole-3-one (OIT), dibromopropionamide (DBNPA), glutaaldehyde, 3-iodo-2-propynylbutylcarbamate (IPBC), terbutrin, 2-methyl-1,2-benzothiazole-3 (2H)-one (MBIT), benzamide, 2,2′-dithiobis (N-methyl) (DTBMA), tetramethylol-acetylenediazole (TMAD), ethylene glycol bishemiformal (EDDM), 2-bromo-2-(Bromomethyl) pentanedinitrile (DBDCB), permethrin, propiconazole (DMI), chlorocresol (PCMC), bronopol, thiabendazole (TBZ), 3-(3,4-dichlorophenyl)-1,1-dimethylurea (3,4-dichlorophenyl)-1,1-dimethylurea (DCMU; diuron), 2-benzyl-4-chlorophenol (chlorophen), phenoxycarb, tebuconazole, isothiazole, cyproconazole, fludioxonyl, azoxystrobin, Zn-pyrythion, alvendadim, thiamethaxam, quaternary ammonium compounds (“quats”) such as n-alkyl dimethyl benzyl ammonium chloride, didecyl dimethyl ammonium chloride (DDAC) or alkenyl dimethylethyl ammonium chloride, guanidines, biguanidines, pyrithiones, carbamates, 3-iodopropynyl-N-butylcarbamate, phosphonium salts such as tetrakis hydroxymethyl phosphonium sulfate (THPS), 3,5-dimethyl-1,3,5-thiadiazinane-2-thione (Dazomet), 2-(thiocyanomethylthio)benzothiazole, methylene bisthiocyanate (MBT), and combinations thereof.

For one embodiment of the invention, preferred bio-active functional additives include 3-iodo-2-propylbutylcarbamate, propiconazole, tebuconazole, copper-8-quinolinate, copper citrate, carbendazim, streptomycin, dichlorooctylisothiazolinone, Irgarol 1051, pentachlorophenol, azoxystrobin.

A further preferred bio-active functional additives include 3-iodo-2-propylbutylcarbamate, propiconazole, tebuconazole, copper-8-quinolinate, 4,5-dichloro-2-octyl-2-H-isothiazole-3-one (DCOIT), Irgarol 1051, pentachlorophenol, and blends thereof, and combinations thereof:

The solubility of many biocides depends strongly on the pH of the solution. For example, the anion, such as citrates and similar polyatomic anions, in many sparingly soluble salts is the conjugate base of a weak acid that may become protonated in solution. The solubility of these compounds such as oxides and citrates is therefore often dependent on pH. At low pH, protonation of the anion can dramatically increase the solubility of the salt. This allows the salt to go into solution, and then raising the pH back to neutral allows for control of the precipitation of the salt. Manipulating the pH of a solution can also help dissolve organic biocides such as pentachlorophenol or other phenols, cresols, and amine containing biocides. Lowering the pH of water can protonate a basic amine making it more soluble in water by generating the positively charged ammonium ion. Phenols can be deprotonated in basic solutions, leading to increased solubility by generating the negatively charged phenolate anion. Many organic compounds, however, have little water solubility regardless of pH. Many of these biocides such as the azoles and isothiazolinones to name only a few, can be dissolved in solvents like ethanol. Once the compound is dissolved in ethanol, water can be added to precipitate the compound. The solvent can also be dried to precipitate the compound inside microcapsules.

Considering the effect of pH and solvent choice on the dissolution and precipitation of compounds, in its one embodiment, the present invention has developed a method to encapsulate organic molecules inside microcapsules.

When the functional additive is a corrosion inhibiting additive, it includes the following: (a) an organic compound containing an amino group or carboxy group or salts of carboxylic acids, organic sulfides, heterocyclic rings, substituted aromatic rings, organic phosphates and phosphonic acids, quaternary ammonium compounds, imidazolines, aldehydes, sulfoxides, carboxylic acids, mercaptocarboxylic acids, imidazoles, oximes, azoles, tannins, substituted phenols, quinoline and quinolone compounds, substituted quinolines and quinalizarin, pyridinium group, pyrazine group, an azole derivative, and, one or more schiffs bases; (b) an inorganic compound containing one or more anions selected from the group comprising polyphosphate and its derivatives, nitrite, silicate, molybdate, and polymolybdate and its derivatives, vanadate and polyvanadate and its derivatives; and (c) an organic or inorganic compound comprising one or more cations selected from the group comprising lanthanides, magnesium, calcium, titanium, zirconium, yttrium, chromium, zinc, strontium and silver; combinations of components within each corrosion inhibiting additive group (a), (b), and (c); and combinations between one or more components of each additive group (a), (b), and (c).

This invention also relates to method preparing such reservoirs, and for releasing the additive. This invention further relates to matrix that comprises such reservoirs and the method of preparing such matrix. This invention also relates to applications, for example in corrosion inhibition, lubrication, and adhesion, that benefit from using such a controlled release of an additive.

F. Method of Releasing the Encapsulated Material from the POHR

The encapsulated material release from the partially-open, hollow reservoirs (POHR) over time, from the one or more openings in the POHR.

In one embodiment, the POHR in combination with its porosity determine the rate and the release of the encapsulated material at a given time. Stated another way, the present invention provides a mechanism for time release of encapsulated materials with the partial opening in the POHR assisting in the time-dependent release of the encapsulated materials. In one embodiment, a combination of POHR with a variety of openings allows for a desired release profile. For example, one embodiment provides for POHR that have an opening in the range of 0.25% to about 50% of the surface area of an effective sphere having equivalent surface area as a POHR microreservoir. In other words, the average size of the opening in percentage terms can be any number from the list below: 0.25, 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50.

In one embodiment, the average size of the openings is within a range defined by any two numbers given above, including the endpoints.

In one embodiment, a desired distribution of microreservoir opening sizes can be prepared. For example, in one distribution, the 25% of the POHR have 20% average opening size, 25% POHR have 30% average opening size, 25% POHR have 35% average opening size, and 25% POHR have 40% average opening size. In one embodiment, the release of the FA can be controlled by controlling the can control the release by controlling the size/number of pores on the surface of the POHR.

The encapsulated material are released over a period of time, due to the one or more openings on the POHR surface.

The ability to release contents from reservoirs in a controlled manner is of significant interest in a variety of applications such as antimicrobial protection and for biocide applications.

Reservoirs can either act as carriers or delivery vehicles to deliver its encapsulated materials at a specific site and/or time, or be used to store specialty chemicals that will be released as and when required. Adding the functional additives to a medium, as encapsulated within the POHR, increases the functional life of such additives in the medium when compared to the life of the same additive that is added directly—that is, without encapsulation in a POHR,—because the encapsulated configuration protects the additives from leaching out or from being consumed up too rapidly.

Polymer-based reservoirs of the core-shell type release their encapsulated material upon mechanical damage, for example, or over time, through the process of leaching, or an external factor such as an impact from solvent type of materials.

### G. Application of POHR Comprising Encapsulating Material or Functional Additive

The microcapsules of the present invention can be used in a variety of applications, for example:
1. bio-active functional additive and matrix comprising such additive;
2. corrosion inhibiting additives and anticorrosive coatings matrix comprising such additives;
3. lubricant additives and lubricant matrix comprising such additives;
4. adhesive additives and adhesive matrix comprising such additives;
5. corrosion sensor additive and corrosion sensor matrix comprising such additive;
6. catalyst additive and catalyst matrix comprising such additive;
7. ink additive and ink matrix comprising such additive;
8. dye additive and matrix comprising such additive;
9. a fragrance releasing additive and matrix comprising such additive;
10. an enzyme additive and enzyme matrix comprising such additive,
11. a drug-delivery additive and drug-delivery matrix; and
12. a reactant additive and a reactant additive matrix comprising such additive.

In the above examples, by “matrix” is meant the medium in which such POHR comprising functional additives are dispersed. The examples of such “matrix” include: paints and coatings to which POHR comprising corrosion inhibitor are added; lubricant oil such as motor oil to which POHR comprising lubricant additives are added; an adhesive such as epoxy or urethane adhesive to which POHR comprising adhesive additive are added, and so on, and so forth. The matrix can be a fluid, solid, semi-solid, gel, sol-gel, dispersion, emulsion, a colloidal suspension, gas-liquid mixture, paste, polymeric matrix, or other such combinations that are amenable to such POHR micro-reservoirs. It is possible that when the POHR are added to the matrix the matrix is in one physical and chemical form, and later on, it changes to another physical and/or chemical form.

### 1. Bio-Active Functional Additive and Matrix Comprising Such Additive

By a “bio-active functional additive” is meant a functional additive that can impact a biological activity, either in enhancing the outcome or mitigating the outcome. So, for example, an insecticide type of functional additive would assist in mitigating the spread of insects-a biological activity. Similarly, an insect-repellant type of functional additive would repel the insects. But an insect-attractant functional additive could attract insects at the locus of the release of the functional additive.

Marine coatings and paint manufacturers customarily add biocides to the paint to prevent or inhibit unwanted infestation of the films by microorganisms, for example, fungi such as molds and yeasts; bacteria; algae; and cyanobacteria (so-called “soft fouling”) when these paints are applied on a vessel or underwater structure such as a pier.

The biocide and the anti-fouling additives have also been effective in some cases in preventing the growth of barnacles, tube worms, and the like (so-called “hard fouling”). However, poor control of biocides release is the main drawback of these systems. Most coatings suffer from premature leakage of biocides, reducing its antifouling action before the end of coatings' lifetime. Alternatively, higher biocide content can be used to reach the required lifecycle, but the continued releasing of those toxic agents into the environment seriously harms the ecosystem, owing to the ecotoxicity and cumulative effect of the applied bioactive agents. Rigid international regulations have been issued as a matter of consequence. Therefore, ability to store biocides or antifoulants in coating for a longer time and its controlled release in coatings over time is of significant importance.

In one embodiment, the bio-active functional additive is selected from the group consisting a biocide additive, a pesticide additive, a pest-attractant additive, a pest-repellant additive, an herbicide additive, an insecticide additive, an insect-attractant additive, an insect-repellant additive, a fungicide additive, a planticide additive, an antifouling additive, an anti-mold agent, a viricide additive, a pheromone, and combinations thereof.

Because the POHR of the present invention have one or more openings on its surface, a release profile can be structured according to the need, as described elsewhere in this application. For example, a continuous release, or a timed release, or a slow release can be tailored according to expectation.

This invention also relates to using multiple bio-active functional additives (BAFA) in one POHR or one BAFA per set of POHR in plurality of POHR sets.

This invention also relates to using multiple biocides in one POHR or one biocide per set of POHR in plurality of POHR sets. Suitable biocides may include triazoles, imidazoles, succinates, benzamides, iodine, phenol, pyridine, quinoline, nitrides, phosphates and their respective derivatives. In one embodiment, suitable biocides can be one or more of an inorganic, organometallic, metal-organic or organic biocide for marine or freshwater organisms.

Examples of inorganic biocides include copper salts such as copper oxide, copper thiocyanate, copper bronze, copper carbonate, copper chloride, copper nickel alloys, and silver salts such as silver chloride or nitrate.

Examples organometallic and metal-organic biocides include zinc pyrithione (the zinc salt of 2-pyridinethiol-1-oxide), copper pyrithione, bis (N-cyclohexyl-diazenium dioxy) copper, zinc ethylene-bis(dithiocarbamate) (i.e. zineb), zinc dimethyl dithiocarbamate (ziram), and manganese ethylene-bis(dithiocarbamate) complexed with zinc salt (i.e. mancozeb).

Examples of organic biocides include formaldehyde, dodecylguanidine monohydrochloride, thiabendazole, N trihalomethyl thiophthalimides, trihalomethyl thiosulphamides, N-aryl maleimides such as N-(2,4,6-trichlorophenyl) maleimide, 3-(3,4-dichlorophenyl) 1,1-dimethylurea (diuron), 2,3,5,6-tetrachloro-4-(methylsulphonyl) pyridine, 2 methylthio-4-butylamino-6-cyclopopylamino-s-triazine, 3-benzo[b]thien-yl-5,6 dihydro-1,4,2-oxathiazine 4-oxide, 4,5-dichloro-2-(n-octyl)-3(2H)-isothiazolone, 2,4,5,6-tetrachloroisophthalonitrile, tolylfluanid, dichlofluanid, diiodomethyl-p tosylsulphone, capsciacin, N-cyclopropyl-N′-(1,1-dimethylethyl)-6-(methylthio)-1,3,5-triazine-2,4-diamine, 3-iodo-2-propynylbutyl carbamate, medetomidine, 1,4-dithiaanthraquinone-2,3-dicarbonitrile (dithianon), boranes such as pyridine triphenylborane, a 2-trihalogenomethyl-3-halogeno-4-cyano pyrrole derivative substituted in position 5 and optionally in position 1, such as 2-(p-chlorophenyl) 3-cyano-4-bromo-5-trifluoromethyl pyrrole (tralopyril), and a furanone, such as 3-butyl-5-(dibromomethylidene)-2(5H)-furanone, and mixtures thereof, macrocyclic lactones such as avermectins, for example avermectin B1, ivermectin, doramectin, abamectin, amamectin and selamectin, and quaternary ammonium salts such as didecyldimethylammonium chloride and an alkyldimethylbenzylammonium chloride.

In one embodiment, the BAFA is a pesticide additive. Pesticides are undoubtedly critical elements of modern agricultural production. They can effectively increase crop yield by reducing plants pests and diseases. However, the traditional pesticide formulations have several disadvantages such as high organic solvent contents, dust drift, poor dispersibility and most importantly most of the pesticide is lost to the environment and less than 1% remains on the target. This low effectiveness contributes to serious environmental pollution associated with pesticides. Therefore, efforts should be taken to reduce waste, production cost and environmental pollution associated with pesticides while also extending the duration of pesticide activity on crops.

One of the methods to address these challenges would be by using precise controlled release of pesticides, an aspect of the present invention. This approach aims to minimize the crop's demand for pesticides to gradually achieve more effective, safe pesticide usage through smart design that slows and controls pesticide release. Controlled release of pesticide allows to greatly improve use of pesticides by reducing waste and pollution.

Examples of pesticides amenable to the POHR encapsulation of the present invention include pyrethroids such as bifenthrin, permethrin, deltamethrin, lambda cyhalothrin, cyfluthrin, or betacyfluthrin; organophosphates such as chlorpyrifos; limonoids such as azadirachtin or meliartenin; phenyl pyrazoles or oxadiazines such as indoxacarb; phthalic acid diamides such as flubendiamide and anthranilic diamides, carbamates such as carbaryl (1-naphthyl N-methylcarbamate), neonicotinoids or nitroguanidines such imidacloprid, thiomethoxam, clothianidin or dinotefuran; diacylhydrazines such as halofenozide; neonicotines such as floconamid; organophosphates such as trichlorfon and pyrazoles such as fipronil.

### 2. Corrosion-Inhibiting Additive and Matrix Comprising Such Additive

To protect metal surface from corrosion and other damages, coatings are applied onto the metal surface. Corrosion inhibitors are added to coatings to slow down or inhibit metal corrosion. The industry standard or incorporating a corrosion inhibitor into a coating is by direct addition. Even though this method is straight forward, the inhibitor may not be directly exposed upon damage to coating, limiting its effectiveness. Also, over time, due to rain, moisture and other environmental factors, the corrosion inhibitor may leach out from the coatings surface and decrease the coating's corrosion inhibition efficiency. Also, conventional coatings fail to provide controllable release, on demand, of the active agents in response to damage, neither exactly at the damaged site of the coating, and nor in the amount needed to correct or completely eliminate damage.

Therefore, a coating comprising capsule or reservoirs comprising functional additive that is a corrosion inhibitors that have ability to release the corrosion inhibitor on-demand at the site of the corrosion-induced damage of the coating will increase the corrosion inhibition life and efficiency of coating.

The POHR of the present invention can be used in industries such as oil and gas, automotive, chemical plants, marine, and industrial facilities, infrastructure such as roads, railings, bridges, tracks, architecture, containers, industrial applications, cladding, decorative, petrochemicals, power generation facilities, water and sewage, municipal, works, and even high-end manufacturing facilities such as clean technology manufacturing. The POHR would be particularly useful in coatings that cover hard-to-reach places that are likely to be ignored for generalized lack of access.

To improve the corrosion-inhibition longevity of coating, the corrosion inhibitor should be preserved for a longer time in the coating and should be made readily and/or immediately available at the corroding site if there is a scratch or mechanical damage on the surface. The corrosion-inhibitor-comprising micro-reservoirs in the anticorrosive coating not only prevent corrosion of metal generally, but heal and protect the metal from further corrosion in case of scratch or mechanical damage on the surface by rapidly arresting the corrosion.

The functional additive that is a corrosion inhibitor to be stored in the microreservoirs of the present invention maybe any corrosion inhibitor known in the prior art which is suitable for the intended purpose. The choice of corrosion inhibitor will depend upon the nature of metal and the metallic structure to be protected, environmental conditions, operating conditions, etc.

A partially-open, hollow reservoir that can release encapsulated corrosion inhibitor, actually at the onset of corrosion would be of great benefit.

Corrosion inhibitors encapsulated in POHR reservoirs are selected from one of more of the following groups:
(i) an organic compound containing an amino group or carboxy group or salts of carboxylic acids, azoles like imidazoles, thiazoles, tetrazoles, and triazoles like (substituted) benzotriazole, and 2-mercaptobenzothiazole; amines like N-phenyl-1.4-phenylenediamine and Schiff bases (condensation products of amine with aldehyde or ketone) such as N,N′-o-phenylen-bis (3-methoxysalicylidenimine); amino acids like tryptophan thiole group compounds such as DMTD or 1-phenyl-2.5-dithiohydrazodicarbonamide; phthalazin derivatives like 2-[(7-anilino-5-[1,2,4] triazolo[3,4-b][1,3,4]thiadiazin-3-yl) methyl] phthalazin-1(2H)-one; tannins and substituted uracils; phosphonic acid group-containing materials such as styrenephosphonic acid; succinic acid; (benzothiazol-2-ylthio) succinic acid; fatty acid derivatives such as linoleic acid and TEOA; tallow oil fatty acid salts; and sulphonates, pyridinium group, pyrazine group, an azole derivative quinoline and quinolone compounds;
(ii) an organic compound containing one or more anions selected from the group comprising polyphosphate and its derivatives, nitrite, silicate, molybdate, and polymolybdate and its derivatives, vanadate and polyvanadate and its derivatives; and,
(iii) an organic or inorganic compound comprising one or more cations selected from the group comprising lanthanides, magnesium, calcium, titanium, zirconium, yttrium, chromium and silver.

The reservoir encapsulated with corrosion inhibitor may be added to a matrix such as pre-treatments, that is, initial binding layer on metal substrates, conversion coatings, primers, formulations of polymer coatings, powder coatings, paints and concrete, in particular in the form of a powder or a suspension.

Corrosion inhibition can be achieved on various metals, such as iron, copper, zinc, and alloys such as steel. Other exemplary metals and metal alloys for corrosion protection using the present invention include aluminum, zinc, magnesium alloys, zinc alloys, copper alloys, and brass. The application fields of the present invention include automotive, aerospace, construction, architecture, transportation, marine, coil, decorative, cladding, etc. That is, the present invention can be used on any object likely to undergo corrosion.

The micro-reservoir additive may be used in aqueous based, solvent based and powder based coatings.

### 3. Lubricant Additives and Matrix Comprising Such Additive

Lubricants are used in applications that typically involve moving metal parts. They reduce the friction generated between moving parts due to wear and heating, for example. Because lubricants also coat metal parts, they help inhibit corrosion. Functional additives are added into lubricants to increase the performance. For example, a lubricant may include antioxidant additives that prevent the oil from thickening; friction modifier additives that increase engine efficiency; dispersant additives that hold contaminants in suspension; antifoam additives that inhibit the production and retention of air bubbles; detergent additives that reduce deposits on metal; and corrosion inhibiting additives to inhibit corrosion of metals.

Encapsulating additives in reservoirs preserves them in the lubricant for a longer time, and provides several benefits such as:
i. timed release of the chemical additive for long term protection;
ii. reduce effective dosage of additive by avoiding deleterious additive-additive interaction;
iii. deliver the desired chemistry at the right time and the right place to achieve performance not possible when added additive directly;
iv. increase lubricant efficiency by delivering the correct amount of additive for maximum effect;
v. reduce waste by increasing the effective dosage of additive to be delivered, consequently lowering cost and providing environmental benefits (e.g., less waste oil going into the environment); and
vi. allow the introduction of biodegradable agents to accelerate the safe and rapid decomposition of waste lubricants.

Lubricant additives that may be encapsulated in microcapsule of the present invention also include antioxidant additives belonging to the class of phenols and its derivatives, aromatic and aryl amines, anti-wear additives belonging to the class of metal alkyltiophosphate, dispersants belonging to class of phenates, sulfurized phenates, salicylates, naphthenates, stearates, carbamates, thiocarbamates, phosphorous derivatives, etc.

### 4. Adhesive Additives and Matrix Comprising Such Functional Additives

This invention also relates to POHR based additives used in adhesives. Adhesives can be gels, pastes, liquids, or any other matrix form. Some examples of adhesives include urethane and epoxy based systems. Adhesives can be thermosetting resin based or thermoplastic based materials. Polymeric gels also are adhesive materials that can be used as matrix in conjunction with the POHR of the present invention.

For example, in electronic devices, conductive elements may be bonded to one another by means of adhesives. In many industries, manufacturers of metal components use structural adhesives to replace conventional fastening techniques such as rivets, bolts, and welding. Adhesives provide improved product performance, aesthetics, reduced overall assembly time, and lower production costs. Additionally, adhesives preclude much of the stress point concentration, corrosion, and component damage often seen with rivets, bolts, welding, and other traditional fastening methodologies.

This invention also relates to using adhesives comprising the POHR in attaching two different types of materials together, e.g., in automotive applications, in order to reduce the overall weight of the structure. For example, in automotive, the inner and outdoor panels, hoods and deck lids can be made of any combination of steel panels, aluminum panels, magnesium alloy panels, copper alloy panels, carbon composite to satisfy structural, weight and appearance requirements.

However, combination of metals (adjacency) increases susceptibility to corrosion because closely spaced metal structures are likely to generate to galvanic action between them.

Therefore, an adhesive composition comprising micro-reservoirs encapsulated with corrosion inhibitor of the present invention effectively inhibits corrosion when two different types of metal are bonded together. The corrosion inhibitor is released when: (i) the POHR is mechanically shattered at the time when two metal pieces are pressed together for bonding; and/or (ii) is released gradually from the POHR after the completion of the adhesive bonding process, and during the life of bonded assembly.

The examples of corrosion inhibitors may include chromate compositions or phosphates, silicates, nitrates, benzoates, for protecting aluminum alloy or magnesium alloy, mercaptobenzothiazoles for copper alloys, sodium molybdate formulations for ferrous alloys, and phosphonic acids combined with amines for steel.

In one embodiment, for an adhesive application, the POHR is an integral part of the control of reaction and curing processes. A curing agent is encapsulated into the POHR and added to adhesives. After applying the adhesive to a screw, for example, the screw tightening action bursts the POHR in between the threads, releasing active materials, which initiate the cure.

In one embodiment, the micro-reservoirs act as spacers; including them in an adhesive results in a predetermined minimum bond-line thickness between two substrates.

### 5. Corrosion Sensor Additive and Matrix Comprising Such Additive

In one embodiment, the functional additive relates to anticorrosive coatings that are frequently used for corrosion prevention of metallic structures and they are often able to delay the corrosion process but not completely prevent it.

Therefore, it is essential to detect corrosion when it occurs, and preferably at its early stage, so that action can be taken to avoid structural damage or loss of function of metals and their alloys. Corrosion sensing coatings are highly desired for corrosion control, especially if the signal can be detected through visual inspection by the naked eye, at a stage much earlier than the appearance of the observable corrosion products.

The POHR of the present invention encapsulating a dye moiety achieves the release of dye in response to corrosion due to change in pH, thereby signaling the event of corrosion directly to the naked eye.

### 6. Catalyst Additive and Catalyst Matrix Comprising Such Additive

Encapsulation of catalyst increases the functional life and storage stability of catalyst. Also, encapsulation allows participation of catalyst in a reaction at a desired time thereby increasing the efficiency of reaction.

In order to use encapsulated catalysts in systems that require catalysts, the microcapsules must be rigid enough to withstand processing and remain stable in order not to leak out or release the catalysts prematurely. The microcapsules must be compatible in the systems.

Furthermore, the microcapsules must be able to release the catalysts at the desirable time. Such release mechanisms are needed for certain applications such as in coatings or adhesives in electronic and health care applications. Therefore, there still remains a need for microcapsules encapsulating catalysts that are stable and rigid and easily made compatible, but at the same time able to release the catalysts in a controlled manner.

### 7. Ink Additive and Matrix Comprising Such Additive

In one embodiment one or more additives for ink are dissolved or dispersed in a solvent and are encapsulated in partially-open, hollow reservoirs of the present invention. The POHR comprising the one or more ink additives are mixed with an ink matrix where such additives' functionality is desired. For example, color pigment, or fluorescent, or luminescent pigment, or an adhesive pigment, that is released over time as described herein can be releasably encapsulated in one embodiment of the invention. The ink matrix herein includes printer ink.

### 8. Dye Additive and Matrix Comprising Such Additive

In one embodiment one or more additives for of a dye, for example for textile or other coloring applications, are dissolved or dispersed in a solvent and are encapsulated in partially-open, hollow reservoirs of the present invention. The POHR comprising the one or more dye additives are mixed with a dye matrix where such additives' functionality is desired. For example, color pigment, or fluorescent, or luminescent pigment, or an adhesive pigment, that is released over time as described herein can be releasably encapsulated in one embodiment of the invention. For example, textiles can be prepared where a luminescent dye is released to make a fabric look more radiant on a continued basis or even in a controlled manner.

### 9. Fragrance Releasing Agent and Matrix Comprising Such Additive

In one embodiment, the functional additive includes a fragrance releasing functional additive. Compositions incorporating one or more sensory markers in the form of a perfume provide a perceived benefit to consumers in that articles treated with the compositions are more aesthetically pleasing to the consumer, including cases where the perfume imparts a pleasant fragrance to the articles treated therewith. One such example is air fresheners. Air fresheners are typical odor modifiers because they employ volatile fragrance agents for odor control by altering a malodor to a more pleasant character or to an acceptable level. Air fresheners were initially used in bathrooms and kitchens and consequently have tended to be more functional than attractive. Air fresheners are now used in bedrooms and living rooms. Thus, an air freshener pack, that slowly releases fragrance over time or a decorative paint that releases fragrance over time would be of significant use. Other fragrance releasing additives include fabric softeners for laundry, scented products, fabric scent, and scented detergents.

In one embodiment, the POHR of the present invention encapsulated with a fragrance moiety achieves the sustained release of fragrance over time.

### 10. Enzyme Additive and Matrix Comprising Such Additive

In one embodiment one or more additives for an enzyme matrix, for example for use in biological reactions, are dissolved or dispersed in a solvent and are encapsulated in partially-open, hollow reservoirs of the present invention. The POHR comprising the one or more enzyme additives are mixed with an enzyme matrix where such additives' functionality is desired. For example, enzyme that is released over time as described herein can be releasably encapsulated in one embodiment of the invention. For example, reactions can be enzymatically catalyzed using the POHR comprising enzyme of the present invention, over time in a controlled manner.

### 11. Drug-Delivery Functional Additive and Matrix Comprising Such Additive

In one embodiment, the bio-active functional additive includes a drug-delivery functional additive.

Delivery of drugs or drug precursors to a wound in a timely and controlled manner can provide superior healing by enabling the on-demand release of drugs. The controlled release of drugs can provide more efficient therapy by reducing side effects and enhancing patient compliance. For example, a smart wound dressing can provide superior healing support by enabling the controlled release of multiple drugs such as antibiotics. Examples of antibiotic drugs include tetracycline, penicillins, terramycins, erythromycin, bacitracin, neomycin, polymycin B, mupirocin, clindamycin and mixtures thereof. Preferred antiseptics include silver sulfadiazine, chlorhexidine, povidone iodine, triclosan, other silver salts, sucralfate, quaternary ammonium salts and mixtures thereof. These drugs are encapsulated and released in a controlled manner.

### 12. Reactant Additive and a Reactant Additive Matrix Comprising Such Additive

In one embodiment one or more additives for a reaction matrix, for example for use in micro-reactions, are dissolved or dispersed in a solvent and are encapsulated in partially-open, hollow reservoirs of the present invention. The POHR comprising the one or more enzyme additives are mixed with a reaction mixture where such additives' functionality is desired. For example, reactant that is released over time as described herein can be releasably encapsulated in one embodiment of the invention. For example, chemical equilibrium of micro-reactions can be changed by changing the concentration of a particular reactant by using the POHR comprising the reactant of the present invention in a controlled manner.

### EXPERIMENTAL

### Example 1—Synthesis of Partially-Open Hollow Microcapsules (POHM) Comprising Polycarbonate

Porous polycarbonate microcapsules were synthesized using water/oil/water (W1/O/W2) emulsion method. 100 mL of aqueous 1% polyvinyl alcohol solution (W1) was added to 400 mL of 10 wt. % polycarbonate solution in dichloromethane (O). The mixture was emulsified using a high-speed stirrer to create a W1/O emulsion. To this emulsion, 1200 ml of 1% aqueous solution of polyvinyl alcohol (W2) was added and the mixture was stirred at high speed to create a W1/O/W2 emulsion. The emulsion was stirred at 35° C. to evaporate dichloromethane, yielding polycarbonate microcapsules with pores.

### Example 2—Synthesis of Partially-Open Hollow Microcapsules (POHM) Comprising Poly(p-Phenylene Ether-Sulphone

Porous poly(p-phenylene ether-sulphone) microcapsules were synthesized using water/oil/water (W1/O/W2) emulsion method. 100 mL of aqueous 1% polyvinyl alcohol solution (W1) was added to 400 ml of 10 wt % poly(p-phenylene ether-sulphone) solution in dichloromethane (O). The mixture was emulsified using a high-speed stirrer to create a W1/O emulsion. To this emulsion, 1200 ml of 1% aqueous solution of Polyvinyl alcohol (W2) was added and the mixture was stirred at high speed to create a W1/O/W2 emulsion. The emulsion was stirred at 35° C. to evaporate dichloromethane, yielding poly(p-phenylene ether-sulphone) microcapsules with pores.

### Example 3—Synthesis of POHM Comprising Polysulfone

Porous polysulfone microcapsules were synthesized using water/oil/water (W1/O/W2) emulsion method. 100 ml of aqueous 1% polyvinyl alcohol solution (W1) was added to 400 ml of 10 wt % polysulfone solution in dichloromethane (O). The mixture was emulsified using a high-speed stirrer to create a W1/O emulsion. To this emulsion, 1200 ml of 1% aqueous solution of polyvinyl alcohol (W2) was added and the mixture was stirred at high speed to create a W1/O/W2 emulsion. The emulsion was stirred at 35° C. to evaporate dichloromethane, yielding polysulfone microcapsules with pores.

### Example 4—Synthesis of POHM Comprising Polyamide

Porous polyamide microcapsules were synthesized using water/oil/water (W1/O/W2) emulsion method. 100 ml of aqueous 1% Polyvinyl alcohol solution (W1) was added to 400 ml of 10 wt % polyamide solution in dichloromethane (O). The mixture was emulsified using a high-speed stirrer to create a W1/O emulsion. To this emulsion, 1200 mL of 1% aqueous solution of polyvinyl alcohol (W2) was added and the mixture was stirred at high speed to create a W1/O/W2 emulsion. The emulsion was stirred at 35° C. to evaporate dichloromethane, yielding polyamide microcapsules with pores.

In the examples below, polycarbonate, poly(p-phenylene ether-sulphone), polysulfone, polyamide microcapsules that are partially open and hollow are used.

### Example 5—Encapsulation of 3-Iodo-2-Propynylbutylcarbamate (IPBC), a Biocidal Preservative Used in Wood Preservation and Coatings Using Precipitation Method

A 0.85M solution of IPBC in ethanol was prepared by adding 30 g of IPBC to 100 g of ethanol. The mixture was stirred for 20 minutes, or until dissolved. Next, 20 g of poly-o-methoxyaniline based POHR were added to the solution, and it was stirred for 2 hours. Simultaneously, 1200 ml of deionized ice water was prepared. After the 2-hour stirring period, the microcapsule-IPBC solution was poured into the water to precipitate the IPBC in the microcapsule. The resulting solution was then filtered and washed with water, followed by drying.

### Example 6—Encapsulation of Propiconazole, a Fungicidal Preservative Used in Wood Preservation and Coatings Using Precipitation Method

A 0.46 M solution of propiconazole in ethanol was prepared by adding 20 g of propiconazole to 100 g of ethanol. The mixture was stirred for 20 minutes, or until dissolved. Next, 20 g of microcapsule were added to the solution, and it was stirred for 2 hours. Simultaneously, 1200 mL of deionized ice water was prepared. After the 2-hour stirring period, the microcapsule-propiconazole solution was poured into the water to precipitate the propiconazole in the microcapsule. The resulting solution was then filtered and washed with water, followed by drying.

### Example 7—Encapsulation of Tebuconazole, a Fungicidal Preservative Used in Wood Preservation and Coatings Using Precipitation Method

A 0.52 M solution of tebuconazole in ethanol was prepared by adding 20 g of tebuconazole to 100 g of ethanol. The mixture was stirred for 20 minutes, or until dissolved. Next, 20 g of microcapsules were added to the solution, and it was stirred for 2 hours. Simultaneously, 1200 ml of deionized ice water was prepared. After the 2-hour stirring period, the microcapsule-tebuconazole solution was poured into the water to precipitate the tebuconazole in the microcapsule. The resulting solution was then filtered and washed with water, followed by drying.

### Example 8—Encapsulation of Dichlorooctylisothiazolinone (DCOIT), a Biocidal Preservative Used in Wood Preservation and Coatings Using Precipitation Method

A 0.56 M solution of DCOIT in ethanol was prepared by adding 20 g of DCOIT to 100 g of ethanol. The mixture was stirred for 20 minutes, or until dissolved. Next, 20 g of polysulfone POHR were added to the solution, and it was stirred for 2 hours. Simultaneously, 1200 ml of deionized ice water was prepared. After the 2-hour stirring period, the microcapsule-DCOIT solution was poured into the water to precipitate the DCOIT inside the microcapsule. The resulting solution was then filtered and washed with water, followed by drying.

### Example 9—Encapsulation of Dichlorooctylisothiazolinone (DCOIT), a Biocidal Preservative Used in Wood Preservation and Coatings Using Solvent Evaporation Method

A 0.56 M solution of DCOIT in ethanol was prepared by adding 20 g of DCOIT to 100 g of ethanol. The mixture was stirred for 20 minutes, or until dissolved. Next, 20 g of polysulfone POHR were added to the solution, and stirred. After 2 hours, the product was heated at 45° C. to evaporate the ethanol completely resulting the encapsulation of DCOIT in microcapsules.

### Example 10: Encapsulation of Dichlorooctylisothiazolinone (DCOIT), a Biocidal Preservative Used in Wood Preservation and Coatings Using In-Situ Method

100 ml of aqueous 1% polyvinyl alcohol solution (W1) was added to 400 ml of 10 wt % polycarbonate and 5 wt % DCOIT solution in dichloromethane (O). The mixture was emulsified using a high speed stirrer to create a W1/O emulsion. To this emulsion, 1200 mL of 1% aqueous solution of Polyvinyl alcohol (W2) was added and the mixture was stirred at high speed to create a W1/O/W2 emulsion. The emulsion was stirred at 35 C to evaporate dichloromethane yielding porous polycarbonate microcapsules with DCOIT.

### Example 11—Encapsulation of Irgarol 1051 (Cybutryrne), a Biocidal Preservative Used in Wood Preservation and Coatings Using Precipitation Method

A 0.63 M solution of Irgarol 1051 in ethanol was prepared by adding 20 g of Irgarol 1051 to 100 g of ethanol. The mixture was stirred for 20 minutes, or until dissolved. Next, 20 g of microcapsules were added to the solution, and it was stirred for 2 hours. Simultaneously, 1200 ml of deionized ice water was prepared. After the 2-hour stirring period, the microcapsule-Irgarol 1051 solution was poured into the water to precipitate the Irgarol inside the microcapsule. The resulting solution was then filtered and washed with water, followed by drying.

### Example 12—Encapsulation of Copper-8-Quinolinate, a Biocidal Preservative Used in Wood Preservation and Coatings Using Precipitation Method

A 0.5 M solution of Para-toluene sulfonic acid (PTSA) was prepared by adding 188.32 g of Para-toluene sulfonic acid to 2.2 Liters of water. Then, 1.1 liters of the 0.5 M PTSA solution were taken, and 40 g of Copper-8-quinolinate were added to it. Next, 80 g of microcapsules powder were added to the above solution, and it was stirred for 1 hour. After 1 hour, the pH was increased to 8 by slow addition of ammonium hydroxide. The solution was filtered and washed with water. The wet cake was then redispersed in 1.1 Liter of 0.5 M PTSA solution containing 40 g of Copper-8-quinolinate, followed by stirring for 1 hour. Again, the pH was increased to 8 by slow addition of ammonium hydroxide. Finally, the solution was filtered, washed with water, and dried.

### Example 13—Encapsulation of Carbendazim a Biocidal Preservative Used in Wood Preservation and Coatings Using Precipitation Method

A 0.83 M solution of carbendazim in ethanol was prepared by adding 20 g of carbendazim to 100 g of ethanol. The mixture was stirred for 20 minutes, or until dissolved. Next, 20 g of microcapsules were added to the solution, and it was stirred for 2 hours. Simultaneously, 1200 mL of deionized ice water was prepared. After the 2-hour stirring period, the microcapsule-carbendazim solution was poured into the water to precipitate the carbendazim inside the microcapsule. The resulting solution was then filtered and washed with water, followed by drying.

### Example 14—Encapsulation of Streptomycin, an Antibiotic Fungicide Used in Wood Preservation and Coatings Using Precipitation Method

A 0.41 M solution of streptomycin in ethanol was prepared by adding 30 g of streptomycin to 100 g of ethanol. The mixture was stirred for 20 minutes, or until dissolved. Next, 20 g of microcapsules were added to the solution, and it was stirred for 2 hours. Simultaneously, 1200 mL of deionized ice water was prepared. After the 2-hour stirring period, the microcapsule-streptomycin solution was poured into the water to precipitate the streptomycin inside the microcapsule. The resulting solution was then filtered and washed with water, followed by drying.

### Example 15—Encapsulation of Copper Citrate, a Biocidal Preservative Used in Wood Preservation and Coatings Using pH Change Method

A 0.5 M solution of para-toluene sulfonic acid (PTSA) was prepared by adding 188.32 g of para-toluene sulfonic acid to 2.2 Liters of water. Then, 1.1 liters of the 0.5 M PTSA solution were taken, and 40 g of copper citrate were added to it. Next, 80 g of microcapsules powder were added to the above solution, and it was stirred for 1 hour. After 1 hour, the pH was increased to 8 by slow addition of ammonium hydroxide. The solution was filtered and washed with water. The wet cake was then redispersed in 1.1 L of 0.5 M PTSA solution containing 40 g of copper citrate, followed by stirring for 1 hour. Again, the pH was increased to 8 by slow addition of ammonium hydroxide. Finally, the solution was filtered, washed with water, and dried.

### Example 16—Encapsulation of Pentachlorophenol, a Biocidal Preservative Used in Wood Preservation and Coatings Using Precipitation Method

A solution of sodium pentachlorophenate in water was prepared by dissolving the salt in water. Thirty (30) g of sodium pentachlorophenate were added to 400 ml of water, and it was stirred to dissolve. Next, 20 g of microcapsules were added to the solution, and it was stirred for 2 hours. After stirring, acid was added to lower the pH of the solution to about 4 to 5. Pentachlorophenol then precipitated. The solution was filtered, washed with water, and dried.

### Example 17—Encapsulation of Azoxystrobin, a Fungicide Used in Wood Preservation and Coatings Using Precipitation Method

A 0.59 M solution of azoxystrobin in ethanol was prepared by adding 30 g of azoxystrobin to 100 g of ethanol. The mixture was stirred for 20 minutes, or until dissolved. Next, 20 g of microcapsules were added to the solution, and it was stirred for 2 hours. Simultaneously, 1200 ml of deionized ice water was prepared. After the 2-hour stirring period, the microcapsule-azoxystrobin solution was poured into the water to precipitate the azoxystrobin inside the microcapsule. The resulting solution was then filtered and washed with water, followed by drying.

### Example 18. Encapsulation of BLS 700, UV Stabilizer Using Precipitation Method

12 g of BLS 700 UV stabilizer was dissolved in 50 g of Butyl acetate. Then, 15 g of microcapsules were added to it, and it was stirred for 2 hours. In a separate beaker, 1000 mL of ethanol:water 70:30 solution was prepared. The ethanol-water solution was poured into the microcapsule/BLS 700 solution with stirring. The resulting solution was filtered, washed with ethanol, and dried.

### Example 19: Encapsulation of BLS 1770FF, Light-Stabilizer Using Precipitation

### Method

A 30 wt % BLS 1770 light stabilizer solution in ethanol was prepared by dissolving 15 g of BLS 1770 FF in 35 ml of ethanol. Next, 20 g of microcapsules were added to this solution and stirred. After 2 hours, the mixture was poured into 1500 mL of ice-cold water with stirring to precipitate out the BLS 1770. The product was filtered, rinsed with DI water, and dried.

### Example 20: Encapsulation of Halox 430, a Calcium Phosphate-Based Corrosion Inhibitor in Microcapsules Using pH Change Method

A 0.5M para-toluene sulfonic acid (PTSA) solution was prepared by adding 188.32 g of para-toluene sulfonic acid to 2.2 Liters of water. Then, 1.1 liters of the 0.5 M PTSA solution were taken, and 42 g of Halox 430 were added to it. Next, 80 g of microcapsules powder were added to the above solution, and it was stirred for 1 hour. After 1 hour, the pH was increased to 8 by slow addition of ammonium hydroxide. The solution was filtered and washed with water. The wet cake was then redispersed in 1.1 L of 0.5 M PTSA solution containing 42 g of Halox 430, followed by stirring for 1 hour. Again, the pH was increased to 8 by slow addition of ammonium hydroxide. Finally, the solution was filtered, washed with water, and dried.

### Example 21: Encapsulation of Nubirox 106, a Zinc Phosphate-Zinc Molybdate-Based Corrosion Inhibitor Inside Microcapsules Using pH Change Method

A 0.5M para-toluene sulfonic acid (PTSA) solution was prepared by adding 188.32 g of para-toluene sulfonic acid to 2.2 L of water. Then, 1.1 L of the 0.5 M PTSA solution were taken, and 42 g of Nubirox 106 were added to it. Next, 80 g of microcapsules powder were added to the above solution, and it was stirred for 1 hour. After 1 hour, the pH was increased to 8 by slow addition of ammonium hydroxide. The solution was filtered and washed with water. The wet cake was then redispersed in 1.1 L of 0.5M PTSA solution containing 42 g of Nubirox 106, followed by stirring for 1 hour. Again, the pH was increased to 8 by slow addition of ammonium hydroxide. Finally, the solution was filtered, washed with water, and dried.

### Example 22: Encapsulation of Magnesium Oxalate Inside Microcapsules Using pH Change Method

A 0.5M para-toluene sulfonic acid (PTSA) solution was prepared by adding 188.32 g of para-toluene sulfonic acid to 2.2 L of water. Then, 1.1 liters of the 0.5 M PTSA solution were taken, and 20 g of magnesium oxalate were added to it. Next, 40 g of microcapsules powder were added to the above solution, and it was stirred for 1 hour. After 1 hour, the pH was increased to 8 by slow addition of ammonium hydroxide. The solution was filtered and washed with water. The wet cake was then redispersed in 1.1 Liter of 0.5M PTSA solution containing 20 g of Magnesium oxalate, followed by stirring for 1 hour. Again, the pH was increased to 8 by slow addition of ammonium hydroxide. Finally, the solution was filtered, washed with water, and dried.

### Example 23: Encapsulation of Zinc Citrate Inside Microcapsules Using pH Change Method

A 0.5M para-toluene sulfonic acid (PTSA) solution was prepared by adding 188.32 g of para-toluene sulfonic acid to 2.2 Liters of water. Then, 1.1 L of the 0.5 M PTSA solution were taken, and 40 g of zinc citrate were added to it. Next, 80 g of microcapsules powder were added to the above solution, and it was stirred for 1 hour. After 1 hour, the pH was increased to 8 by slow addition of ammonium hydroxide. The solution was filtered and washed with water. The wet cake was then redispersed in 1.1 L of 0.5M PTSA solution containing 40 g of zinc citrate, followed by stirring for 1 hour. Again, the pH was increased to 8 by slow addition of ammonium hydroxide. Finally, the solution was filtered, washed with water, and dried.

### Example 24: Encapsulation of Lithium Carbonate Inside Microcapsules Using Precipitation Method

A lithium sulfate solution of 20 g/L was prepared and heated to 50° C. Then, 40 g of microcapsules were added to this solution and stirred for 1 hour. Subsequently, a saturated sodium carbonate solution was slowly added to the solution to precipitate out lithium carbonate. The resulting product was then filtered, washed with water, and dried.

### Example 25: Encapsulation of Lithium Phosphate Inside Microcapsules Using pH Change Method

A 0.5M para-toluene sulfonic acid (PTSA) solution was prepared by adding 188.32 g of para-toluene sulfonic acid to 2.2 Liters of water. Next, 1.1 L of the 0.5 M PTSA solution were taken, and 42 g of lithium phosphate were added to it. Following that, 80 g of microcapsules powder were added to the above solution, and it was stirred for 1 hour. After 1 hour, the pH was increased to 8 by slow addition of ammonium hydroxide. The solution was filtered and washed with water. The wet cake was then redispersed in 1.1 L of 0.5M PTSA solution containing 42 g of lithium phosphate, followed by stirring for 1 hour. Again, the pH was increased to 8 by slow addition of ammonium hydroxide. Finally, the solution was filtered, washed with water, and dried.

### Example 26: Encapsulation of Zinc Phosphate Inside Microcapsules Using pH Change Method

A 0.5M para-toluene sulfonic acid (PTSA) solution was prepared by adding 188.32 g of para-toluene sulfonic acid to 2.2 Liters of water. Then, 1.1 liters of the 0.5 M PTSA solution were taken, and 42 g of zinc phosphate were added to it. Next, 80 g of microcapsules powder were added to the above solution, and it was stirred for 1 hour. After 1 hour, the pH was increased to 8 by slow addition of ammonium hydroxide. The solution was filtered and washed with water. The wet cake was then redispersed in 1.1 Liter of 0.5M PTSA solution containing 42 g of zinc phosphate, followed by stirring for 1 hour. Again, the pH was increased to 8 by slow addition of ammonium hydroxide. Finally, the solution was filtered, washed with water, and dried.

### Example 27: Encapsulation of Calcium Oxalate Inside Microcapsules Using pH Change Method

A 0.5M para-toluene sulfonic acid (PTSA) solution was prepared by adding 188.32 g of para-toluene sulfonic acid to 2.2 L of water. Then, 1.1 liters of the 0.5 M PTSA solution were taken, and 42 g of calcium oxalate were added to it. Next, 80 g of microcapsules powder were added to the above solution, and it was stirred for 1 hour. After 1 hour, the pH was increased to 8 by slow addition of ammonium hydroxide. The solution was filtered and washed with water. The wet cake was then redispersed in 1.1 L of 0.5M PTSA solution containing 42 g of calcium oxalate, followed by stirring for 1 hour. Again, the pH was increased to 8 by slow addition of ammonium hydroxide. Finally, the solution was filtered, washed with water, and dried.

### Example 28: Encapsulation of Magnesium Citrate Inside Microcapsules Using pH Change Method

A 0.5M Para-toluene sulfonic acid (PTSA) solution was prepared by adding 188.32 g of Para-toluene sulfonic acid to 2.2 Liters of water. Then, 1.1 liters of the 0.5 M PTSA solution were taken, and 42 g of magnesium citrate were added to it. Next, 80 g of microcapsules powder were added to the above solution, and it was stirred for 1 hour. After 1 hour, the pH was increased to 8 by slow addition of ammonium hydroxide. The solution was filtered and washed with water. The wet cake was then redispersed in 1.1 Liter of 0.5M PTSA solution containing 42 g of magnesium citrate, followed by stirring for 1 hour. Again, the pH was increased to 8 by slow addition of ammonium hydroxide. Finally, the solution was filtered, washed with water, and dried.

### Example 29: Encapsulation of Cerium Oxalate Inside Microcapsules Using pH Change Method

42 g of cerium oxalate were added to 2 M, 500 ml sulfuric acid solution. Next, 80 g of microcapsules powder were added to the above solution, and it was stirred for 1 hour. After 1 hour, the pH was increased to 8 by slow addition of ammonium hydroxide. The solution was filtered and washed with water. The wet cake was then redispersed in 2 M, 500 ml sulfuric acid solution containing 42 g of cerium oxalate, followed by stirring for 1 hour. Again, the pH was increased to 8 by slow addition of ammonium hydroxide. Finally, the solution was filtered, washed with water, and dried.

### Example 30: Encapsulation of Lithium Oxalate Inside Microcapsules Using pH Change Method

A 0.5M Para-toluene sulfonic acid (PTSA) solution was prepared by adding 188.32 g of Para-toluene sulfonic acid to 2.2 Liters of water. Then, 1.1 liters of the 0.5 M PTSA solution were taken, and 42 g of lithium oxalate were added to it. Next, 80 g of microcapsules powder were added to the above solution, and it was stirred for 1 hour. After 1 hour, the pH was increased to 8 by slow addition of ammonium hydroxide. The solution was filtered and washed with water. The wet cake was then redispersed in 1.1 Liter of 0.5M PTSA solution containing 42 g of lithium oxalate, followed by stirring for 1 hour. Again, the pH was increased to 8 by slow addition of ammonium hydroxide. Finally, the solution was filtered, washed with water, and dried.

### Example 31: Encapsulation of Phosphate Ester Inside Microcapsules Using Precipitation Method

5 g of phosphate ester was dissolved in 100 ml isopropanol. Then, 5 g of microcapsules were added to this solution and stirred for 1 hour. After 1 hour, 300 g of ice-cold water was added to the mixture to precipitate phosphate ester out of solution inside microcapsules. The resulting product was filtered, washed, and dried.

### Example 32: Encapsulation of Benzoyl Phenyl Thiourea Using Precipitation Method

In 100 g of ethanol, 7.5 g of benzoyl phenyl thiourea was dissolved. Next, 10 g of microcapsules were added to the solution and stirred for 1 hour. After 1 hour, 1 liter of ice-cold water was added to it to precipitate benzoyl phenyl thiourea out of solution. The product was filtered, washed, and dried.

### Example 33: Encapsulation of Halox 650 Using Precipitation Method

In 100 g of ethanol, 7.5 g of Halox 650 was dissolved. Next, 10 g of microcapsules were added to the solution and stirred for 1 hour. After 1 hour, 1 liter of ice-cold water was added to it to precipitate Halox 650 out of solution. The product was filtered, washed, and dried.

### Example 34: Microencapsulated Biocide-Based Antifouling Coating

Acrylic based antifouling coating was formulated using polycarbonate microcapsules encapsulated with DCOIT. Below is the starting point formulation.

TABLE 2
Starting Point Formulation for Waterborne Acrylic Coating:

| | | |
|---|---|---|
| Material Name | Supplier | Amount (g) |

Grind stage: Grind at high speed for 30 min the ingredients below

| | | |
|---|---|---|
| DI Water | | 21.88 |
| Disperbyk 2012 | Evonik | 3.28 |
| Disperbyk 1710 | BYK | 0.54 |
| TiO2 - TiPure R765 | Chemours | 32.7 |
| Microcapsule/DCOIT | SAS Nanotechnologies | 1 |
| Avanse MV 100 | Dow | 130.3 |
| Additol VXW 6360 | Allnex | 0.88 |

Let-down stage: After grind, add the ingredient below with stirring

| | | |
|---|---|---|
| Tego Wet 265 | Evonik | 1.76 |
| Dowanol DPM Glycol Ether | Dow | 7.66 |

| | |
|---|---|
| Total | 200 |

1. A plurality of partially-open, hollow reservoirs (POHR), comprising at least one polymeric material and optionally at least one functional additive;
wherein said at least one polymeric material comprises only non-conducting at least one polymer;
wherein said plurality of POHR have at least one opening on their surface, such that the average opening area, in the aggregate, of said plurality of POHR is from about 0.25% to about 50% of the surface area in the aggregate of said plurality of POHR;
wherein the average size of said plurality of POHR is in the range of from about 200 nm to about 30,000 nm;
wherein said at least one functional additive releasably resides in said plurality of POHR.

2. The plurality of partially-open, hollow reservoirs as recited in claim 1, wherein said non-conducting at least one polymer is selected from polysulfone, poly(p-phenylene ether-sulphone), polycarbonate, polyamide, a polymeric blend comprising one of the previously recited polymers, a copolymer of one of the previously recited polymers, and a combination of previously recited polymers.

3. The plurality of partially-open, hollow reservoirs as recited in claim 1, wherein said at least one functional additive is selected from the group consisting of a corrosion inhibiting additive, a lubricant additive, an adhesive additive, a bio-active additive, a fragrance-releasing additive, a drug delivery additive, an enzyme additive, a corrosion sensor additive, a catalyst additive, an ink additive, a dye additive, a cosmetic additive, a UV stabilizer, a light stabilizer, and combinations thereof.

4. The plurality of partially-open, hollow reservoirs as recited in claim 3, wherein said bio-active functional additive is selected from the group consisting a biocide additive, a pesticide additive, a pest-attractant additive, an pest-repellant additive, an herbicide additive, an insecticide additive, an insect-attractant additive, an insect-repellant additive, a fungicide additive, a planticide additive, an antifouling additive, an antifungal additive, an anti-mold agent, a viricide additive, a pheromone, and combinations thereof.

5. The plurality of POHR as recited in claim 4, wherein said at least one bio-active functional additive is an antifungal additive.

6. The plurality of partially-open, hollow reservoirs as recited in claim 4, wherein said bio-active functional additive is selected from triazoles, imidazoles, succinates, benzamides, iodine, phenol, pyridine, quinoline, nitrides, phosphates and their respective derivatives;
inorganic, organometallic, metal-organic or organic biocide for marine or freshwater organisms, inorganic biocides selected from copper salts, copper oxide, copper thiocyanate, copper bronze, copper carbonate, copper chloride, copper nickel alloys, silver salts, silver chloride, silver nitrate;
organometallic and metal-organic biocides, zinc pyrithione (the zinc salt of 2-pyridinethiol-1-oxide), copper pyrithione, bis (N-cyclohexyl-diazenium dioxy) copper, zinc ethylene-bis(dithiocarbamate) (i.e. zineb), zinc dimethyl dithiocarbamate (ziram), manganese ethylene-bis(dithiocarbamate) complexed with zinc salt (i.e. mancozeb);
3-iodo-2-propylbutylcarbamate, propiconazole, tebuconazole, copper-8-quinolinate, copper citrate, carbendazim, streptomycin, dichlorooctylisothiazolinone, Irgarol 1051, pentachlorophenol, azoxystrobin, 1,2-benzisothiazole-3 (2H)-one (BIT), 5-chloro-2-methyl-2H-isothiazole-3-one CMIT) and 2-methyl-2H-isothiazole-3-one MIT), 4,5-dichloro-2-octyl-2-H-isothiazole-3-one (DCOIT), 2-methyl-2H-isothiazole-3-one (MIT), 2-Octyl-2H-isothiazole-3-one (OIT), dibromopropionamide (DBNPA), glutaaldehyde, 3-iodo-2-propynylbutylcarbamate (IPBC), terbutrin, 2-methyl-1,2-benzothiazole-3 (2H)-one (MBIT), benzamide, 2,2′-dithiobis (N-methyl) (DTBMA), tetramethylol-acetylenediazole (TMAD), ethylene glycol bishemiformal (EDDM), 2-bromo-2-(Bromomethyl) pentanedinitrile (DBDCB), permethrin, propiconazole (DMI), chlorocresol (PCMC), bronopol, thiabendazole (TBZ), 3-(3,4-dichlorophenyl)-1,1-dimethylurea (3,4-dichlorophenyl)-1,1-dimethylurea (DCMU; diuron), 2-benzyl-4-chlorophenol (chlorophen), phenoxycarb, isothiazole, cyproconazole, fludioxonyl, azoxystrobin, Zn-pyrythion, alvendadim, thiamethaxam, quaternary ammonium compounds (“quats”) such as n-alkyl dimethyl benzyl ammonium chloride, didecyl dimethyl ammonium chloride (DDAC) or alkenyl dimethylethyl ammonium chloride, guanidines, biguanidines, pyrithiones, carbamates, 3-iodopropynyl-N-butylcarbamate, phosphonium salts such as tetrakis hydroxymethyl phosphonium sulfate (THPS), 3,5-dimethyl-1,3,5-thiadiazinane-2-thione (Dazomet), 2-(thiocyanomethylthio)benzothiazole, methylene bisthiocyanate (MBT);
Pyrethroids, bifenthrin, permethrin, deltamethrin, lambda cyhalothrin, cyfluthrin, betacyfluthrin; organophosphates, chlorpyrifos; limonoids, azadirachtin, meliartenin; phenyl pyrazoles; oxadiazines; indoxacarb; phthalic acid diamides, flubendiamide, anthranilic diamides; carbamates, carbaryl (1-naphthyl N-methylcarbamate), neonicotinoids; nitroguanidines, imidacloprid, thiomethoxam, clothianidin, dinotefuran; diacylhydrazines, halofenozide; neonicotines such as floconamid; organophosphates, trichlorfon and pyrazoles, fipronil, and combinations thereof.

7. The plurality of partially-open, hollow reservoirs as recited in claim 6, wherein said bio-active functional additive is selected from: 3-iodo-2-propylbutylcarbamate, propiconazole, tebuconazole, copper-8-quinolinate, copper citrate, carbendazim, streptomycin, dichlorooctylisothiazolinone, Irgarol 1051, pentachlorophenol, azoxystrobin, and combinations thereof.

8. The plurality of partially-open, hollow reservoirs as recited in claim 7, wherein said bio-active functional additive is selected from: 3-iodo-2-propylbutylcarbamate, propiconazole, tebuconazole, copper-8-quinolinate, 4,5-dichloro-2-octyl-2-H-isothiazole-3-one (DCOIT), Irgarol 1051, pentachlorophenol, and blends thereof, and combinations thereof.

9. The plurality of partially-open, hollow reservoirs as recited in claim 4, wherein said functional additive is a corrosion inhibiting additive selected from (a) an organic compound containing an amino group or carboxy group or salts of carboxylic acids, organic sulfides, heterocyclic rings, substituted aromatic rings, organic phosphates and phosphonic acids, quaternary ammonium compounds, imidazolines, aldehydes, sulfoxides, carboxylic acids, mercaptocarboxylic acids, imidazoles, oximes, azoles, tannins, substituted phenols, quinoline and quinolone compounds, substituted quinolines and quinalizarin, pyridinium group, pyrazine group, an azole derivative, and, one or more schiffs bases; (b) an inorganic compound containing one or more anions selected from the group comprising polyphosphate and its derivatives, nitrite, silicate, molybdate, and polymolybdate and its derivatives, vanadate and polyvanadate and its derivatives; and (c) an organic or inorganic compound comprising one or more cations selected from the group comprising lanthanides, magnesium, calcium, titanium, zirconium, yttrium, chromium, zinc, strontium and silver; combinations of components within each corrosion inhibiting additive group (a), (b), and (c); and combinations between one or more components of each additive group (a), (b), and (c).

10. The plurality of partially-open, hollow reservoirs as recited in claim 4, wherein said functional additive or encapsulating material is a lubricant additive selected from: (i) antioxidant additives selected from phenols and its derivatives, aromatic and aryl amines; (ii) anti-wear additives selected from metal alkylthiophosphate; (iii) dispersants selected from of phenates, sulfurized phenates, salicylates, naphthenates, stearates, carbamates, thiocarbamates, phosphorus derivatives; combinations of components within each lubricant additive group (i), (ii), and (iii); and combinations between one or more components of each lubricant additive group (i), (ii), and (iii).

11. The plurality of partially-open, hollow reservoirs as recited in claim 4, wherein said functional additive is an adhesive additive selected from the following adhesive additive functional additives:
chromate compositions, phosphates, silicates, nitrates, benzoates, mercaptobenzothiazoles, sodium molybdate formulations, phosphonic acids combined with amines, and combinations thereof.

12. The plurality of partially-open, hollow reservoirs as recited in claim 1, wherein said partially-open, hollow reservoirs are nominally spherical-shaped hollow reservoirs, nominally rod-shaped hollow reservoirs, irregular-shaped hollow reservoirs, or a hollow micro-particles with more than one opening.

13. A method for preparing POHR comprising a first polymer, said method comprising the steps of:
(i) contacting a first aqueous solution (W1) comprising a first surfactant, or a first emulsion stabilizer, and/or a second polymer with a solution of said first polymer in a solvent (O);
(ii) emulsifying the resultant mixture of step (i) into a W1/O emulsion;
(iii) contacting said emulsion of step (ii) with a second aqueous solution (W2) comprising a second surfactant, a second emulsion stabilize, and/or a third polymer;
(iv) emulsifying the resultant mixture of step (iii) to form a W1/O/W2 emulsion; and
(v) evaporating said solvent from said W1/O/W2 emulsion;
wherein said first surfactant is the same as or different from the second surfactant, the first emulsion stabilizer is the same as or different from the second emulsion stabilizer, and the second polymer is the same as or different from the third polymer.

14. A method for encapsulating at least one functional additive (FA) in a plurality of partially-open, hollow reservoir (POHR) as recited in claim 1, or in an inorganic POHR, said method selected from the following four methods: (I) a precipitation method; (II) a solvent evaporation method; (III) a pH change method; and (IV) an in-situ method,
wherein:
I. said precipitation method comprises the steps of:
i. dissolving at least one FA in a solvent to form a first solution in presence of said plurality of POHR, or
ii. dissolving at least one FA in a solvent to form a second solution and contacting said second solution to said plurality of POHR; and
iii. precipitating out said at least one FA out of said first solution or second solution in the POHR;
II. said solvent evaporation method comprises the steps of:
iv. dissolving at least one FA in a first solvent to form a first solution, in presence of said plurality of POHR;
v. dissolving at least one FA in a second solvent to form a second solution and contacting said second solution to said plurality of POHR; and
v. precipitating said at least one FA out of said first solution or second solution in POHR by evaporating the first solvent or the second solvent, wherein the first solvent and the second solvent are the same or different from each other;
III. said pH change method comprises the steps of:
vi. dissolving at least one FA in an acidic or basic medium to form a first solution, in presence of said plurality of POHR, or
vii. dissolving at least one FA in an acidic or basic medium to form a second solution and contacting said second solution to said plurality of POHR; and
viii. precipitating out said at least one FA out of said first solution or second solution in the POHR by changing the pH to neutral; and
IV. said in-situ method comprises the step of adding at least one FA dissolved in a solvent to the POHR synthesis reaction medium prior to the synthesis of the POHR, or during the synthesis of POHR.

15. The method as recited in claim 14, wherein said non-conducting at least one polymer is selected from polysulfone, poly(p-phenylene ether-sulphone), polycarbonate, and polyamide, a polymeric blend comprising one of the previously recited polymers, a copolymer of one of the previously recited polymers, and a combination of previously recited polymers.

16. The method as recited in claim 14, wherein said at least one functional additive is selected from the group consisting of a corrosion inhibiting additive, a lubricant additive, an adhesive additive, a bio-active additive, a fragrance-releasing additive, a drug delivery additive, an enzyme additive, a corrosion sensor additive, a catalyst additive, an ink additive, a dye additive, a cosmetic additive, a UV stabilizer, a light stabilizer, and combinations thereof.

17. The method as recited in claim 16, wherein said bio-active functional additive is selected from the group consisting a biocide additive, a pesticide additive, a pest-attractant additive, an pest-repellant additive, an herbicide additive, an insecticide additive, an insect-attractant additive, an insect-repellant additive, a fungicide additive, a planticide additive, an antifouling additive, an antifungal additive, an anti-mold agent, a viricide additive, a pheromone, and combinations thereof.

18. The method as recited in claim 17, wherein said bio-active functional additive is selected from triazoles, imidazoles, succinates, benzamides, iodine, phenol, pyridine, quinoline, nitrides, phosphates and their respective derivatives;
inorganic, organometallic, metal-organic or organic biocide for marine or freshwater organisms, inorganic biocides selected from copper salts, copper oxide, copper thiocyanate, copper bronze, copper carbonate, copper chloride, copper nickel alloys, silver salts, silver chloride, silver nitrate;
organometallic and metal-organic biocides, zinc pyrithione (the zinc salt of 2-pyridinethiol-1-oxide), copper pyrithione, bis (N-cyclohexyl-diazenium dioxy) copper, zinc ethylene-bis(dithiocarbamate) (i.e. zineb), zinc dimethyl dithiocarbamate (ziram), manganese ethylene-bis(dithiocarbamate) complexed with zinc salt (i.e. mancozeb);
3-iodo-2-propylbutylcarbamate, propiconazole, tebuconazole, copper-8-quinolinate, copper citrate, carbendazim, streptomycin, dichlorooctylisothiazolinone, Irgarol 1051, pentachlorophenol, azoxystrobin, 1,2-benzisothiazole-3 (2H)-one (BIT), 5-chloro-2-methyl-2H-isothiazole-3-one CMIT) and 2-methyl-2H-isothiazole-3-one MIT), 4,5-dichloro-2-octyl-2-H-isothiazole-3-one (DCOIT), 2-methyl-2H-isothiazole-3-one (MIT), 2-Octyl-2H-isothiazole-3-one (OIT), dibromopropionamide (DBNPA), glutaaldehyde, 3-iodo-2-propynylbutylcarbamate (IPBC), terbutrin, 2-methyl-1,2-benzothiazole-3 (2H)-one (MBIT), benzamide, 2,2′-dithiobis (N-methyl) (DTBMA), tetramethylol-acetylenediazole (TMAD), ethylene glycol bishemiformal (EDDM), 2-bromo-2-(Bromomethyl) pentanedinitrile (DBDCB), permethrin, propiconazole: (DMI), chlorocresol (PCMC), bronopol, thiabendazole (TBZ), 3-(3,4-dichlorophenyl)-1,1-dimethylurea (3,4-dichlorophenyl)-1,1-dimethylurea (DCMU; diuron), 2-benzyl-4-chlorophenol (chlorophen), phenoxycarb, tebuconazole, isothiazole, cyproconazole, fludioxonyl, Zn-pyrythion, alvendadim, thiamethaxam, quaternary ammonium compounds (“quats”) such as n-alkyl dimethyl benzyl ammonium chloride, didecyl dimethyl ammonium chloride (DDAC) or alkenyl dimethylethyl ammonium chloride, guanidines, biguanidines, pyrithiones, carbamates, 3-iodopropynyl-N-butylcarbamate, phosphonium salts such as tetrakis hydroxymethyl phosphonium sulfate (THPS), 3,5-dimethyl-1,3,5-thiadiazinane-2-thione (Dazomet), 2-(thiocyanomethylthio)benzothiazole, methylene bisthiocyanate (MBT);
pyrethroids, bifenthrin, permethrin, deltamethrin, lambda cyhalothrin, cyfluthrin, betacyfluthrin; organophosphates, chlorpyrifos; limonoids, azadirachtin, meliartenin; phenyl pyrazoles; oxadiazines; indoxacarb; phthalic acid diamides, flubendiamide, anthranilic diamides; carbamates, carbaryl (1-naphthyl N-methylcarbamate), neonicotinoids; nitroguanidines, imidacloprid, thiomethoxam, clothianidin, dinotefuran; diacylhydrazines, halofenozide; neonicotines such as floconamid; organophosphates, trichlorfon and pyrazoles, fipronil, and combinations thereof.

19. The method as recited in claim 17, wherein said bio-active functional additive is selected from: 3-iodo-2-propylbutylcarbamate, propiconazole, tebuconazole, copper-8-quinolinate, copper citrate, carbendazim, streptomycin, dichlorooctylisothiazolinone, Irgarol 1051, pentachlorophenol, azoxystrobin, and combinations thereof.

20. The method as recited in claim 17, wherein said bio-active functional additive is selected from: 3-iodo-2-propylbutylcarbamate, propiconazole, tebuconazole, copper-8-quinolinate, 4,5-dichloro-2-octyl-2-H-isothiazole-3-one (DCOIT), Irgarol 1051, pentachlorophenol, and combinations thereof.

21. The method as recited in claim 16, wherein said functional additive is a corrosion inhibiting additive is selected from selected from (a) an organic compound containing an amino group or carboxy group or salts of carboxylic acids, organic sulfides, heterocyclic rings, substituted aromatic rings, organic phosphates and phosphonic acids, quaternary ammonium compounds, imidazolines, aldehydes, sulfoxides, carboxylic acids, mercaptocarboxylic acids, imidazoles, oximes, azoles, tannins, substituted phenols, quinoline and quinolone compounds, substituted quinolines and quinalizarin, pyridinium group, pyrazine group, an azole derivative, and, one or more schiffs bases; (b) an inorganic compound containing one or more anions selected from the group comprising polyphosphate and its derivatives, nitrite, silicate, molybdate, and polymolybdate and its derivatives, vanadate and polyvanadate and its derivatives; and (c) an organic or inorganic compound comprising one or more cations selected from the group comprising lanthanides, magnesium, calcium, titanium, zirconium, yttrium, chromium, zinc, strontium and silver; combinations of components within each corrosion inhibiting additive group (a), (b), and (c); and combinations between one or more components of each additive group (a), (b), and (c).

22. A matrix comprising the plurality of partially-open, hollow reservoirs as recited in claim 5, or an inorganic POHR comprising functional additive selected from the group consisting of a corrosion inhibiting additive, a lubricant additive, an adhesive additive, a bio-active additive, a fragrance-releasing additive, a drug delivery additive, an enzyme additive, a corrosion sensor additive, a catalyst additive, an ink additive, a dye additive, a cosmetic additive, a UV stabilizer, a light stabilizer, and combinations thereof;
wherein said bio-active functional additive is selected from the group consisting a biocide additive, a pesticide additive, a pest-attractant additive, a pest-repellant additive, an herbicide additive, an insecticide additive, an insect-attractant additive, an insect-repellant additive, a fungicide additive, a planticide additive, an antifouling additive, an antifungal additive, an anti-mold agent, a viricide additive, a pheromone, and combinations thereof.

23. A process for preparing a matrix comprising the plurality of partially-open, hollow reservoirs as recited in claim 1 or an inorganic POHR comprising such FA, comprising the steps of:
i. contacting said POHR with said matrix, and optionally
ii. mixing said POHR in said matrix.

24. The process as recited in claim 22, wherein said matrix is a paint, coating wood preservative, paint, coating, or a polymeric material;
wherein and said at least one functional additive is selected from the group consisting of a corrosion inhibiting additive, a lubricant additive, an adhesive additive, a bio-active additive, a fragrance-releasing additive, a drug delivery additive, an enzyme additive, a corrosion sensor additive, a catalyst additive, an ink additive, a dye additive, a cosmetic additive, a UV stabilizer, a light stabilizer, and combinations thereof; and
wherein said bio-active functional additive is selected from the group consisting a biocide additive, a pesticide additive, a pest-attractant additive, a pest-repellant additive, an herbicide additive, an insecticide additive, an insect-attractant additive, an insect-repellant additive, a fungicide additive, a planticide additive, an antifouling additive, an antifungal additive, an anti-mold agent, a viricide additive, a pheromone, and combinations thereof.

25. The process as recited in claim 24, wherein the matrix is injected or applied alone or as a component in latexes, amino resins, polyurethanes, epoxies, phenolic resins, polyester resins, alkyd resins, polyaspartic, polyurea, polylactones, adducts of amines, polyimide, polycarbonate, polyvinyl and halogenated polymer resins.

26. A process for initiating biological activity on a surface, comprising the step of coating said surface with a matrix comprising the partially-open, hollow reservoirs as recited in claim 1 or an inorganic POHR comprising functional additive, wherein the functional additive is selected from the group consisting a biocide additive, a pesticide additive, a pest-attractant additive, an pest-repellant additive, an herbicide additive, an insecticide additive, an insect-attractant additive, an insect-repellant additive, a fungicide additive, a planticide additive, an antifouling additive, an antifungal additive, an anti-mold agent, a viricide additive, a pheromone, and combinations thereof.

27. The process as recited in claim 26, wherein the matrix coating is latexes, amino resins, polyurethanes, epoxies, phenolic resins, acrylic resins, polyester resins, alkyd resins, polysulfide resins, polyaspartic, polyurea, polylactones, adducts of amines, polyimide, polycarbonate, polyvinyl and halogenated polymer resins.

28. The process as recited in claim 26, wherein said surface is part of a fence, deck, part of a pier, marine vehicle, marine vehicle part, or part of a piece of equipment, architectural cladding, flying object, or part of a flying object, industrial machinery, or industrial machinery parts, pipes, pipe parts, tanks, tank parts, part of a decorative piece, and a part for decorative purposes, structures used in power sector or other infrastructure, wood or metal structures used in energy sector, and wood or metal structures used in the transportation sectors.
